(19) United States
(12) Patent Application Publication
(10) Pub. No.: US 2026/0348439 A1
(43) Pub. Date: Nov. 5, 2026

(54) CLUTCH FOR AN ACTUATOR FOR A HUMANOID ROBOT

(71) Applicant: Figure AI Inc., San Jose, CA (US)

(72) Inventor: Jacob Daniel Webb, San Jose, CA (US)

(21) Appl. No.: 19/742,906

(22) Filed: Jul. 15, 2026

Related U.S. Application Data
(63) Continuation-in-part of application No. 19/040,860, filed on Jan. 29, 2025.
(60) Provisional application No. 63/626,085, filed on Jan. 29, 2024.

(51) Int. Cl. F16D 48/06; B25J 9/10; F16D 25/0635

(52) U.S. Cl. CPC F16D 48/062; B25J 9/1025; F16D 25/0635; F16D 2500/1045; F16D 2500/30406; F16D 2500/50233; F16D 2500/70406

(57) ABSTRACT

A torque protection apparatus for a humanoid robot actuator protects a high-reduction strain wave gearbox from damage caused by transient overload torque. The apparatus is arranged co-axially with the gearbox and includes an output ring, formed by the circular spline of the strain wave gearbox, having opposed planar disc surfaces that are axially clamped between first and second clutch friction plates. An outer body surrounds the gearbox and connects to an output adaptor, while an inner body within the outer body bounds a sealed annular hydraulic chamber holding a captive incompressible liquid. A hydraulic adjustment piston pressurizes the liquid, biasing the inner body axially against the friction plates and output ring to set a threshold breakaway torque. Below the threshold, the friction plates transmit full gearbox torque to the output adaptor.

### PRIORITY CLAIM AND CROSS-REFERENCE TO RELATED APPLICATIONS

This application is a continuation-in-part of U.S. Application No. 19/040,860, filed Jan. 29, 2025, which claims priority under 35 U.S.C. § 119(e) to U.S. Provisional Patent Application No. 63/626,085, filed Jan. 29, 2024, which is expressly incorporated by reference herein in its entirety.

### TECHNICAL FIELD

This disclosure relates to a clutch for a robot, specifically a clutch for an actuator configured to be positioned within a humanoid robot.

### BACKGROUND

The current labor market within the United States is confronting an unprecedented labor shortage, characterized by over 10 million unfilled positions. A significant proportion of these vacancies pertain to occupations that are deemed unsafe, undesirable, or involve hazardous working conditions. This persistent and escalating shortage of available labor has created an urgent imperative for the development and deployment of advanced robotic systems capable of performing tasks that are unattractive or pose risks to human workers. To effectively address this widening gap in the workforce, it has become critical to design and engineer robots that can operate with high efficiency and reliability within human-centric environments. These environments often demand capabilities such as physical dexterity, sustained endurance, precise manipulation, and the ability to navigate complex spaces designed for humans.

Advanced general-purpose humanoid robots have emerged as a promising solution to meet these challenges. These robots are meticulously engineered to replicate the human form and emulate human functionality, typically featuring bipedal locomotion with two legs, bilateral manipulation abilities with two arms, and a display to facilitate interaction with human users. The anthropomorphic design enables these robots to seamlessly integrate into environments originally designed for humans, thereby minimizing the need for extensive modifications to existing infrastructures. As these robots endeavor to mimic the human body, it becomes essential to equip them with actuators to enable them to move and perform human-like tasks. However, there is a need to protect these actuators and the components they are coupled to in the event that the rotational torque transmitted from the motor exceeds a design strength of an attached gearbox or other attached components structural failures can occur.

### SUMMARY

In accordance with one aspect of the present disclosure, a humanoid robot is provided comprising a torque protection apparatus for an actuator of the humanoid robot. The torque protection apparatus includes a gearbox having an input coupled to a motor and an output ring having a first planar surface and a second planar surface, an outer body surrounding the gearbox and coupled to an output adaptor, an inner body positioned within the outer body, a first clutch friction plate positioned between the first planar surface of the output ring and the output adaptor, a second clutch friction plate positioned between the second planar surface of the output ring and the inner body, a fluid chamber defined between the inner body and the outer body, fluid contained within the fluid chamber, and a hydraulic adjustment piston configured to pressurize the fluid within the fluid chamber to bias the inner body toward the output ring. The torque protection apparatus is configured to operate in a first state when a rotational torque transmitted through the gearbox is below a threshold torque value, wherein the pressurized fluid causes the inner body to press the first and second clutch friction plates against the first and second planar surfaces of the output ring with sufficient force such that the first and second clutch friction plates do not slip relative to the output ring, thereby causing the output adaptor to rotate at the same rotational velocity as the circular spline. The torque protection apparatus is further configured to operate in a second state when the rotational torque transmitted through the gearbox exceeds the threshold torque value, wherein the first and second clutch friction plates slip relative to the first and second planar surfaces of the output ring, thereby preventing transmission of torque exceeding the threshold torque value to the output adaptor.

In accordance with another aspect of the present disclosure, a humanoid robot is provided comprising a plurality of rotary actuators positioned at respective joints of the humanoid robot, each rotary actuator comprising a strain wave gearbox having an output ring with opposed planar disc surfaces, an outer body surrounding the gearbox and coupled to an output adaptor, an inner body within the outer body, at least one friction plate axially clamped between the output ring and the output adaptor, a sealed annular chamber holding a captive incompressible liquid between the inner body and the outer body, and a pressure mechanism accessible through the outer body of each rotary actuator and configured to set a pressure of the captive liquid, whereby each rotary actuator is independently configured with a breakaway slip torque corresponding to the liquid pressure of that rotary actuator. The humanoid robot further comprises a control system that monitors an operational metric for each rotary actuator and generates a notification when the operational metric meets a predetermined threshold, the notification identifying a reduction in liquid pressure for the corresponding rotary actuator.

In one embodiment, the inner body includes an inner ring section, an outer ring section, and a plurality of circumferentially spaced projections defining receivers therebetween, the receivers receiving projections of the outer body to transmit torque while permitting axial translation of the inner body toward the output ring. In an alternative embodiment, the inner body comprises an inner ring section bonded to the outer body and a flexible coupling section configured to axially deflect relative to the outer body to press against the output ring when the captive liquid is pressurized. The hydraulic adjustment piston has external threads engaged with internal threads of a pressure bore in the outer body and carries one or more O-ring seals that slide against a smooth inner diameter of the pressure bore, wherein advancing the hydraulic adjustment piston into the pressure bore reduces the total fluid volume and increases the liquid pressure, and retracting the hydraulic adjustment piston decreases the liquid pressure, thereby permitting the breakaway slip torque to be set and subsequently adjusted through external access to the hydraulic adjustment piston. In one embodiment, the gearbox is a hollow-type strain wave gearbox comprising a wave generator coupled to the motor, a flexspline, and a circular spline forming the output ring, wherein the first and second planar surfaces are defined on a mounting projection that radially extends from a cylindrical member of the circular spline.

According to an aspect of the present disclosure, the torque protection apparatus further comprises a gas bleed piston mounted in a bleed bore separate from the pressure bore of the hydraulic adjustment piston and a second passageway extending from the bleed bore to the fluid chamber, the gas bleed piston being sealed against the bleed bore after gas has been removed from the fluid chamber, so that the captive liquid within the fluid chamber behaves as an incompressible liquid and the breakaway slip torque remains stable. In one embodiment, a pressure adjustment motor is coupled to the hydraulic adjustment piston and is configured to adjust the position of the hydraulic adjustment piston within the pressure bore to change the pressure of the fluid and thereby change the threshold torque value. In one embodiment, the breakaway slip torque of at least one rotary actuator is set to a value in a range of 250 Nm to 280 Nm to prevent overload torque from being transmitted through a strain wave gearbox having a maximum torque rating of 300 Nm. The control system is configured to track at least one wear metric selected from total operational time, cumulative gearbox rotations, cumulative torque cycles, slip-event count, and temperature proximate the gearbox or the torque protection apparatus, and to generate a notification recommending reduction of fluid pressure when a predetermined threshold value for a tracked wear metric is met, wherein in embodiments where a pressure adjustment motor is coupled to the hydraulic adjustment piston, the control system automatically commands the pressure adjustment motor to decrease the pressure of the captive liquid without manual intervention when the operational metric meets the predetermined threshold.

The torque protection apparatus of the present disclosure provides the technical advantage of a normally-engaged, self-resetting clutch that slips when the applied torque exceeds the threshold torque value and automatically re-engages when the applied torque falls below that threshold, thereby preventing ratcheting of the mating teeth within the gearbox that can otherwise occur when opposing teeth disengage under excess torque. Because the breakaway slip torque is governed by the relationship ST = R·μ·P·A, where ST is the maximum torque transmitted through the clutch, R is the effective radius of the clutch friction plate in contact with the output ring, μ is the coefficient of friction between the clutch friction plate and the output ring, P is the pressure of the fluid in the fluid chamber, and A is the effective area of the inner body, the threshold torque value is directly and continuously adjustable by varying the fluid pressure through displacement of the hydraulic adjustment piston, enabling the breakaway slip torque to be set individually for each actuator in accordance with the design strengths of the corresponding gearbox and downstream components coupled to the output adaptor.

The integration of the torque protection apparatus co-axially within the actuator drivetrain, combined with the captive incompressible liquid and externally accessible pressure mechanism, supports standardization of actuator types across the humanoid robot, reducing the need for specialized parts while permitting each actuator to be independently configured for the torque requirements of its respective joint, including joints in the torso, spine, hips, and knees. The wear-adaptive control capability, by which the control system tracks accumulated operational metrics and generates notifications or automatically commands the pressure adjustment motor to reduce the liquid pressure as wear accumulates, reduces the peak stresses transmitted to aging gearboxes and extends the operational lifespan of the actuators without risking catastrophic failure of the gearbox or attached components during extended operational deployments of the humanoid robot.

### BRIEF DESCRIPTION OF THE DRAWINGS

The drawing figures depict one or more implementations in accordance with the present teachings, by way of example only, not by way of limitation. These figures are intended to illustrate and not to restrict the scope of the disclosure. In the figures, like reference numerals refer to the same or similar elements. This convention is maintained throughout the drawings for consistency.

FIG. 1 is a front perspective view of a first embodiment of a humanoid robot;

FIG. 2 is a front perspective view of a second embodiment of a humanoid robot;

FIG. 3 is a front perspective view of a third embodiment of a humanoid robot;

FIG. 4 is a perspective view of an actuator configured to be contained within any one of the first, second, and third embodiments of the humanoid robot of FIGS. 1-3;

FIG. 5 is a semi-transparent cross-sectional view of a portion of the actuator taken along line 5-5 of FIG. 4, and wherein the outer body of the clutch is highlighted;

FIG. 6 is a semi-transparent rear perspective view of the actuator of FIG. 4, and wherein the inner body of the clutch is highlighted;

FIG. 7 is a perspective cross-sectional view of the portion of the actuator taken along line 7-7 of FIG. 4, showing said actuator includes a first embodiment of a clutch coupled to a gearbox, wherein the clutch includes: (i) an outer body, (ii) an inner body, (iii) at least one clutch plate, and (iv) an adjustment mechanism;

FIG. 8A is a cross-sectional view of the portion of the actuator taken along 8-8 line of FIG. 4, and showing a first extent of the inner body of the clutch;

FIG. 8B is a zoomed-in cross-sectional view of the portion of the actuator of FIG. 7A;

FIG. 9A is a cross-sectional view of the portion of the actuator taken along line 7-7 of FIG. 4, and showing a second extent of the inner body of the clutch and the adjustment mechanism;

FIG. 9B is a zoomed-in cross-sectional view of the portion of the actuator of FIG. 9A;

FIG. 10A is a cross-sectional view of a portion of the actuator taken along line 8-8 of FIG. 4, showing said actuator includes a second embodiment of a clutch coupled to a gearbox; and

FIG. 10B is a zoomed-in cross-sectional view of the portion of the actuator of FIG. 10A.

### DETAILED DESCRIPTION

In the following detailed description, numerous specific details are set forth by way of examples in order to provide a thorough understanding of the relevant teachings. These examples are illustrative and not exhaustive. It should be apparent to those skilled in the art that the scope of the teachings is not limited to these specific details. Additionally or alternatively, well-known methods, procedures, components, and/or circuitry have been described at a relatively high-level, without detail, in order to avoid unnecessarily obscuring aspects of the present disclosure.

While this disclosure includes several embodiments, there is shown in the drawings and will herein be described in detail certain embodiments with the understanding that the present disclosure is to be considered as an exemplification of the principles of the disclosed methods and systems and is not intended to limit the broad aspects of the disclosed concepts to the embodiments illustrated. As will be realized, the disclosed methods and systems are capable of other and different configurations, and one or more details are capable of being modified, all without departing from the scope of the disclosed methods and systems. For example, one or more of the following embodiments, in part or whole, may be combined consistent with the disclosed methods and systems. As such, one or more steps from the flow charts or components in the Figures may be selectively omitted and/or combined consistent with the disclosed methods and systems. Additionally, one or more steps from the flow charts or the method of assembling the shoulder and upper arm may be performed in a different order. Accordingly, the drawings, flow charts and detailed description are to be regarded as illustrative in nature, not restrictive or limiting.

References in the specification to "one embodiment," "an embodiment," "an illustrative embodiment," etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of "at least one A, B, and C" can mean (A); (B); (C); (A and B); (A and C); (B and C); or (A, B, and C). Similarly, items listed in the form of "at least one of A, B, or C" can mean (A); (B); (C); (A and B); (A and C); (B and C); or (A, B, and C). The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

### Introduction

The present disclosure pertains to a humanoid robot 1A-C designed to emulate human form and functionality, enabling it to perform a wide array of tasks in various operational environments. The humanoid robot 1A-C is engineered to undertake both general and specific tasks, ranging from walking long distances and obtaining objects from bins to executing complex, dexterous actions in human-centric settings. Unlike traditional automation systems, this robot can perform tasks that demand advanced motor skills, environmental adaptability, and sophisticated decision-making processes. Examples of such tasks include assembling components in production lines, precision machining, and operating heavy machinery, as well as more everyday activities such as tidying up spaces, preparing meals, and providing customer service. Humanoid robot 1A-C comprises multiple systems, assemblies, components, and parts, each designed with anthropomorphic characteristics to facilitate human-like movements and interactions.

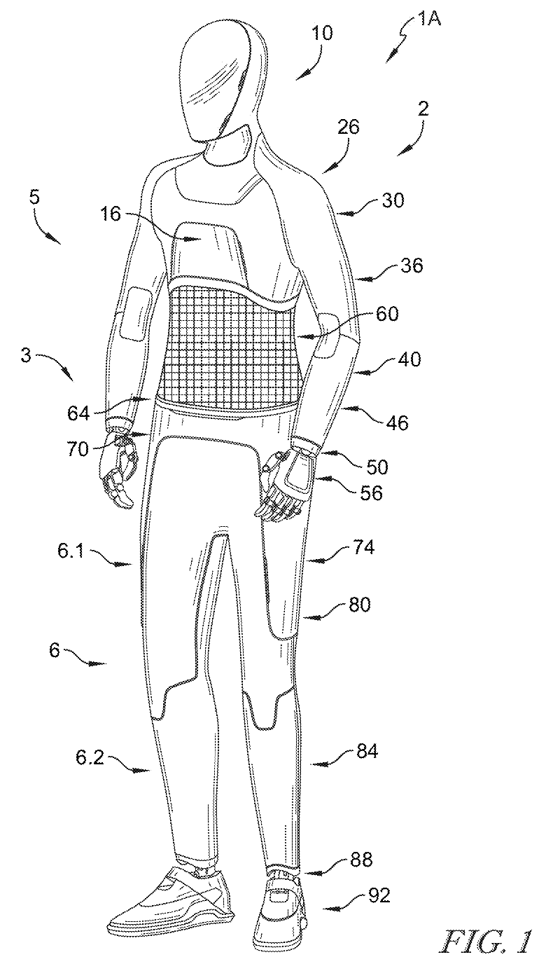

Examples of the humanoid robot 1A-C (shown as robot 1A and robot 1B) are illustrated in FIGS. 1A-1B. Generally, the humanoid robot 1A-C features a human-like anatomical structure, including a head/neck 10, a torso 16, two arms 5, two hands 56, a spine 60, a pelvis 64, and two legs 6. Each arm 5 may comprise a shoulder 26, upper humerus 30, lower humerus 36, upper forearm 40, lower forearm 46, and wrist 50. Each leg 6 include a hip 70, upper thigh 76, lower thigh 80, shin 84, talus 88, and foot 92. The spine 60 provides a central axis for the robot’s structure, enabling it to maintain balance and perform a variety of movements. This anatomical design allows robot 1A-C to interact with its environment in a manner similar to a human, providing it with the versatility and adaptability necessary for performing a wide range of tasks.

Although the general anatomical structure of robot 1A and robot 1B may be similar, the specific kinematic layout including number, size, and relative positions of the actuators in said robots 1A, 1B may vary. For example, humanoid robot 1B may be equipped with 62 degrees of freedom (DoF), strategically distributed across its upper, central, and lower portions. Specifically, 48 degrees of freedom are located in the upper portion 2, 10 degrees of freedom in the central portion 3, and 4 degrees of freedom in the lower portion 4. This distribution ensures that robot 1A-C can perform complex, dexterous tasks with its upper body while maintaining stability and mobility with its lower body. The strategic placement of the degrees of freedom also allows for a larger torso 16, accommodating a more substantial battery pack and additional computing power, thereby enhancing the robot’s performance and reliability. Other embodiments of humanoid robot 1A and robot 1B may include fewer or more degrees of freedom than the illustrative examples of robot 1A and robot 1B.

For example, the 62 degrees of freedom may be achieved through a combination of 42 electric rotary and linear actuators (J1-J16), with an overwhelming majority being electric rotary actuators. This design choice eliminates the need for hydraulic or pneumatic actuators, reducing assembly, maintenance, weight, and cost while increasing durability and safety. The actuators are classified into seven primary types, with five of these types sharing similar structures and assembly methods. This standardization of actuator types reduces the need for specialized parts, increases assembly speeds, and simplifies debugging and documentation. The actuators are distributed unevenly throughout robot 1, with the upper portion housing the majority of the actuators, ensuring that robot 1A-C can execute intricate tasks with precision and dexterity. Other embodiments of humanoid robot 1A-C may include fewer or more electric rotary actuators than the illustrative examples of robot 1A and robot 1B.

Unlike conventional actuators, the disclosed actuator has a small diameter and a high torque density. This is beneficial for the actuator’s use in building robots, including general-purpose humanoid robots like robot 1. To achieve these capabilities, the disclosed actuator includes a hollow-type strain wave gearbox coupled to an output adapter and a custom cross-roller bearing. The strain wave gearbox of the disclosed actuator assembly includes a flexible externally-toothed gear that includes a non-conventional cross-section that allows the flex spline to displace without increasing the strain to damaging levels. The disclosed flexible externally-toothed gear is configured to reduce the volume occupied in the axial direction to provide a more compact design without compromising the torque, position, and efficiency of the strain wave gearbox.

### Definitions

Unless defined otherwise, all technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Although selected human medical terminology is used to describe features and/or relative positions related to the humanoid robot, it should be understood that said medical terminology may not directly correspond to the exact same features of a human. It should be understood that names of various assemblies and components (e.g., including housings and assemblies contained within) may generally relate to a location of similar anatomy of a human body and may not have an exact correlation in dimension, function, or shape. The reference system including three orthogonal reference planes is defined with respect to the robot in a neutral standing position to describe relative positions of components of the robot. Although standard human medical terminology is used to describe the anatomical reference planes (i.e., sagittal, coronal, transverse) of the robot, the planes may be shifted from the typical location on a human to be meaningful for the kinematic layout and features of the robot.

Humanoid Robot: a robot that is capable of bipedal locomotion and includes components (e.g., head, torso, etc.) that generally resemble parts of a human. However, the robot does not need to include every part of a human (e.g., hands with over ten degrees of freedom), nor do its components need to have a shape that exactly or substantially resembles human parts. Furthermore, it should be understood that a humanoid robot is not designed to be primarily quadruped or have a wheeled base.

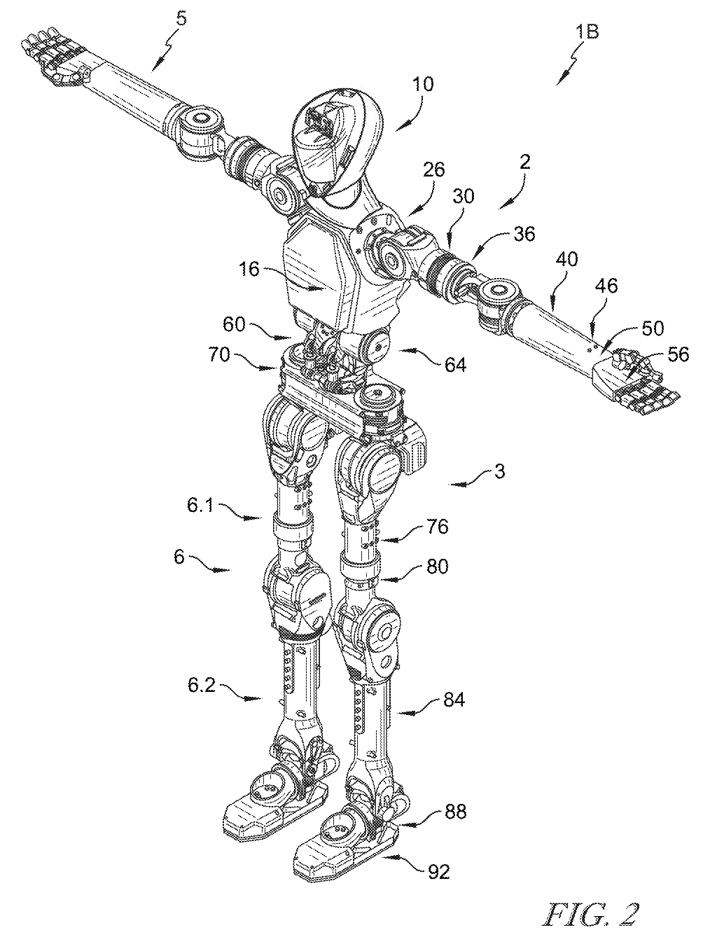

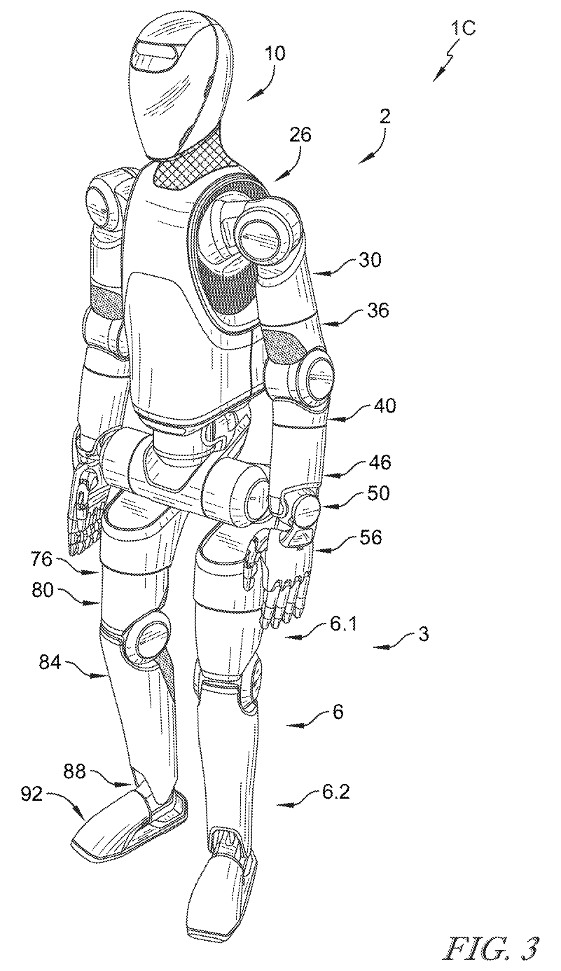

Neutral State: a state where the robot is standing upright on a horizontal support surface and facing a forward direction with its torso substantially vertically aligned over its pelvis and legs, where the legs are substantially straight with the knees substantially aligned under the hips and substantially above the ankles, such that the robot's weight is balanced over its feet. In the neutral state, the robot's head is facing forward (i.e., in the forward direction), the arms are located at the sides of the robot, the hands are oriented with the palms facing substantially inward, and the fingers pointing in a substantially downward direction toward the horizontal support surface. An illustrative example of the neutral state for the humanoid robot 1A-C is shown FIGS. 1-3.

Extended State: a state of the robot with the arms extended outward laterally at the shoulder and oriented with the palms of the hands substantially facing downward and the fingers pointing in a substantially outward direction, where the central and lower portions of the robot remain in a neutral state.

Sagittal Plane: a vertical plane when the robot is in the neutral state that aids in defining left and right sides of the robot for all states. Accordingly, the sagittal plane may: (i) divide the robot and/or the torso into left and right portions or halves, (ii) extend through an axis of rotation about which the torso twists or rotates relative to the pelvis and legs, (iii) contain an origin point of the robot, and/or (iv) be positioned between the left and right legs, and/or left and right arms. In an illustrative embodiment, the sagittal plane is a vertical plane positioned at a midway point between the left and right legs and the left and right arms and contains a rotational axis of a torso twist actuator (J10) located in the spine 60 of the robot 1A-C and divides the left and right sides of the robot 1A-C. In other words, in an illustrative embodiment, the sagittal plane is a plane that is colinear with the rotational axis of the torso twist actuator (J10).

Coronal Plane: a vertical plane when the robot is in the neutral state that aids in defining front and back portions of the robot for all states. Accordingly, the coronal plane may: (i) divide the robot and/or the torso into front and back portions or halves, (ii) contain an axis of rotation about which the torso pitches forward or backward from the neutral state, (iii) contain an axis of rotation of a knee joint about which a lower shin pitches forward and backward, and/or (iv) contains an axis of rotation of an elbow joint about which a lower forearm moves forward and backward, when the robot is in the extended state. In various embodiments, said axis of rotation for torso pitch may be two colinear axes, a single centrally located axis, an axis defined by a line connecting the midpoints of two non-collinear actuator axes that provide the torso pitch function, or an axis defined by a line connecting the center of actuator bearings of two actuators that provide the torso pitch function. In the illustrative embodiment, the coronal plane is a vertical plane that contains the rotational axes A₁₁ of the hip flex actuators (J11) located in the hips 70 (and likewise may contain an axis defined by a line connecting the midpoints of a left hip flex actuator (J11) axis and a right hip flex actuator (J11) axis and rotational axis of torso twist actuator (J10) located in the spine 60 of the robot 1A-C. As shown in these figures, the coronal plane does not bisect the robot, or torso, into equal front and back halves, as it is offset forward of a majority of the arm actuators in the extended position, and other positional relationships that can be understood from the figures.

Transverse Plane: a horizontal plane that aids in defining the upper and lower portions of the robot. Accordingly, the transverse plane may: (i) divide the robot into upper and lower portions or halves, and/or (ii) contain an axis of rotation about which the torso pitches forward or backward, as discussed above. In the illustrative embodiment, the transverse plane is a horizontal plane that contains the mid-point of the rotational axes A₁₁ of the hip flex actuators (J11) located in the hips 70 of the robot 1A-C.

Origin Point: an orthogonal intersection point of the sagittal plane, coronal plane, and transverse plane, all of which extend through the humanoid robot disclosed herein.

Reference Axes: consist of: (i) the Z-axis (vertical) is defined pursuant to the intersection of the sagittal plane and coronal plane, (ii) the Y-axis (horizontal) is defined pursuant to the intersection of the coronal plane and transverse plane; and (iii) the X-axis (depth) is defined pursuant to the intersection of the sagittal plane and transverse plane.

Kinematic Chain: a representation of an assembly of rigid bodies connected by joints to provide constrained motion. Within this application, a kinematic chain is illustrated by cylindrical bodies, where the respective central axis of each individual cylindrical body represents the position and orientation of the axis of rotation for the individual joints. For example, each rotary actuator has a central rotational axis. Other types of actuators may include linkages that provide rotational movement about one or more rotational axes via linkages, bearing or other rotation features, or other means.

Range of Motion: a range of rotational motion of an actuator about an axis of rotation, where a first and second angle define a rotational limit in opposing rotational directions from a neutral position of the actuator with the limits expressed in Radians.

Degrees of Freedom (DoF): the number of parameters that define the configuration of the kinematic chain and possible movements associated therewith.

Singularities: geometric configurations of the robot's joints in which one or more degrees of freedom are effectively lost due to the alignment or overlap of rotational or translational axes, which in some cases is also affected by interference of extents of components where one or more of the components are moved by the joint.

Actuator Bearing: a specific component of the individual actuator that is generally ring-shaped with parallel edge guides, wherein the rotational axis of the actuator is centered within the actuator bearing and orthogonal to the parallel edge guides. Within this application, the actuator bearings of individual actuators are referenced to further define orientation of the rotational axes and/or relative size of the individual actuator.

Actuator bearing plane a plane defined mid-width of actuator bearing between parallel edge guides and orthogonal to the rotational axis.

Textile: a flexible (e.g., fabric-like), highly durable cover material that has high elastic stretch capabilities and is resistant to pilling, abrasions, and cuts. A textile includes both common textiles (e.g., traditional woven cloth),engineered textiles, and non-fabric-like materials (e.g., plastics or polymers), and/or a combination of the above.

### Humanoid Robot

The present disclosure pertains to a humanoid robot 1A-C designed to emulate human form and functionality, enabling it to perform a wide array of tasks in various operational environments. The humanoid robot 1A-C is engineered to undertake both general and specific tasks, ranging from walking long distances and obtaining objects from bins to executing complex, dexterous actions in human-centric settings. Unlike traditional automation systems, this robot can perform tasks that demand advanced motor skills, environmental adaptability, and sophisticated decision-making processes. Examples of such tasks include assembling components in production lines, precision machining, and operating heavy machinery, as well as more everyday activities such as tidying up spaces, preparing meals, and providing customer service. Humanoid robot 1A-C comprises multiple systems, assemblies, components, and parts, each designed with anthropomorphic characteristics to facilitate human-like movements and interactions.

Examples of the humanoid robot 1A-C (shown as robot 1A, robot 1B, and robot 1C) are illustrated in FIGS. 1-3. Generally, the humanoid robot 1A-C features a human-like anatomical structure, including a head/neck 10, a torso 16, two arms 5, and two legs 6. Each arm comprises a shoulder 26, upper humerus 30, lower humerus 36, upper forearm 40, lower forearm 46, wrist 50, and hand 56. The legs include a pelvis 64, left and right hips 70, upper thigh 76, lower thigh 80, shin 84, talus 88, and foot 92. The spine 60 provides a central axis for the robot’s structure, enabling it to maintain balance and perform a variety of movements. This anatomical design allows robot 1A-C to interact with its environment in a manner similar to a human, providing it with the versatility and adaptability necessary for performing a wide range of tasks.

The systems, assemblies, components, and parts of the humanoid robot 1A-C in the illustrative embodiments shown in FIGS. 1-3 can be broadly categorized into three regions. As shown in FIGS. 1-3, these three regions include: (i) an upper portion 2, which includes the head and neck assembly 10, the torso 16, left and right arm assemblies 5, and the left and right hands 56; (ii) a central portion 3, which includes the spine 60, the pelvis 64, and the left and right upper leg assemblies 6.1 of left and right leg assemblies 6; and (iii) a lower portion 4, which includes the left and right lower leg assemblies 6.2 of leg assemblies 6. Each arm assembly 5 may include a shoulder 26, an upper humerus 30, a lower humerus 36, an upper forearm 40, a lower forearm 46, and a wrist 50 as shown in FIGS. 1-3. The hand 56 is coupled to the wrist 50. Each leg assembly 6 may include: (i) an upper leg assembly 6.1, which may comprise a hip 70, an upper thigh 76, and a lower thigh 80, and, (ii) a lower leg assembly 6.2, which may comprise a shin 84, a talus 88, and a foot 92 as shown in FIGS. 1-3.

Although the general anatomical structure of robots 1A-C may be similar, the specific kinematic layout including number, size, and relative positions of the actuators in said robots 1A-C may vary. For example, humanoid robot 1C may be equipped with 62 degrees of freedom (DoF), strategically distributed across its upper, central, and lower portions. Specifically, 48 degrees of freedom are located in the upper portion 2, 10 degrees of freedom in the central portion 3, and 4 degrees of freedom in the lower portion 4. This distribution ensures that robot 1A-C can perform complex, dexterous tasks with its upper body while maintaining stability and mobility with its lower body. The strategic placement of the degrees of freedom also allows for a larger torso 16, accommodating a more substantial battery pack and additional computing power, thereby enhancing the robot’s performance and reliability. Other embodiments of humanoid robot 1A-C may include fewer or more degrees of freedom than the illustrative examples of robot 1A and robot 1B.

For example, the 62 degrees of freedom may be achieved through a combination of 42 electric rotary and linear actuators (J1-J16), with an overwhelming majority being electric rotary actuators. This design choice eliminates the need for hydraulic or pneumatic actuators, reducing assembly, maintenance, weight, and cost while increasing durability and safety. The actuators are classified into 7 primary types, with 5 of these types sharing similar structures and assembly methods. This standardization of actuator types reduces the need for specialized parts, increases assembly speeds, and simplifies debugging and documentation. The actuators are distributed unevenly throughout robot 1, with the upper portion housing the majority of the actuators, ensuring that robot 1A-C can execute intricate tasks with precision and dexterity. Other embodiments of humanoid robot 1A-C may include fewer or more electric rotary actuators than the illustrative examples of robot 1A, robot 1B, and robot 1C.

Unlike conventional actuators, the disclosed actuator 100, 1100 has a small diameter and a high torque density. This is beneficial for the actuator’s use in building robots, including general-purpose humanoid robots like robot 1. To achieve these capabilities, the disclosed actuator 100, 1100 includes a hollow-type strain wave gearbox 108, 1108 coupled to an output adapter 400, 1400 and a custom cross-roller bearing 200, 1200. The strain wave gearbox 108, 1108 of the disclosed actuator assembly 100, 1100 includes a flexible externally toothed gear 108.6, 1108.6 that includes a non-conventional cross-section that allows the flex spline to displace without increasing the strain to damaging levels. The disclosed flexible externally toothed gear 108.6, 1108.6 is configured to reduce the volume occupied in the axial direction to provide a more compact design without compromising the torque, position, and efficiency of the strain wave gearbox 108, 1108.

Additionally, the disclosed actuator 100, 1100 also has a clutch 700, 1700 that provides a torque protection system to protect the gearbox 108, 1108 and devices coupled to the output adapter 400, 1400 from being exposed to forces that can break or damage the coupled devices. The clutch 700, 1700 prevents torque above a predetermined value from being transmitted to other components of the actuator assembly 100, 1100 to protect the gearbox 108, 1108 and the other components of the actuator assembly 100, 1100 connected to the clutch 700, 1700, in the event that the rotational torque transmitted exceeds a design strength of different components. When the break-away slip torque is exceeded, the output ring 108.2, 1108.2 of the gearboxes 108, 1108 can slide against the clutch 700, 1700 so that torque is not transmitted. If the torque applied to the clutch 700, 1700 is reduced or falls below the set breakaway torque value, then the output ring 108.2, 1108.2 may stop sliding and re-engage. In this way, the clutch 700, 1700 may also prevent “ratcheting” of teeth within the gearbox 108, 1108, which may occur when excessive torque causes opposing teeth within the gearbox 108, 1108 to disengage and slide against each other, potentially breaking or otherwise damaging the teeth.

The disclosed actuator 100, 1100 may only be used in selective locations on the robot 1A-C. The torque protection provided by the clutch 700, 1700 prevents or reduces the likelihood of mechanical skew or misalignment, but the clutch 700, 1700 may (i) add weight to the actuator 100, 1100, and thus the robot 1A-C and (ii) add complexity to the actuator 100, 1100, which may increase the build time and cost. Therefore, the actuator 100, 1100 may only be incorporated into some actuators in certain sections of the robot 1A-C, while other actuators without a respective clutch 700, 1700 may be used for the remaining sections. For example, the actuator 100, 1100 may be included in (i) the torso 16 or spine 60 (e.g., the torso lean actuator (J9) and/or the torso twist actuator (J10)), (ii) the hips 70 (e.g., the hip flex actuators (J11) and/or the hip roll actuators (J12)), (iii) the knees (e.g., the knee actuator (J14)). The actuators in these sections are important for the overall mobility of the robot 1A-C and maintaining the robot 1A-C in the upright or neutral position. The clutch 700, 1700 included in the actuators 100, 1100 in these sections may protect the respective gearbox 108, 1108 from excessive torque. In some embodiments, the actuator 100, 1100 may be used in other sections of the robot 1A-C, such as the finger assemblies of the hand assembly 56 of the robot 1A-C, which experience large amounts of external loads during operation.

The clutch 700, 1700 included in the actuators 100, 1100 may also controllably lock the respective actuator 100, 1100 to (i) prevent the robot 1A-C from falling or collapsing in its designated work area, (ii) prevent the robot 1A-C from falling or collapsing when the robot 1A-C is near other objects or people, (iii) maintain a predetermined posture during certain situations, and/or (iv) power down actuators during non-use. For example, the robot 1A-C can be configured to maneuver into a docked state on a docking station for charging and then lock certain actuators 100, 1100 (e.g., actuators in the knees, ankles, hips 70, pelvis 64, spine 60, etc.) to maintain the predetermined posture during charging. This not only maintains the robot 1A-C in the predetermined posture for charging, increasing the likelihood that the charge is maintained while the robot 1A-C is on the docking stations, but also allows the robot 1A-C to power down the actuators in the knees, ankles, hips, and/or pelvis during recharging. Another example includes locking the actuators in the arms 5 when the arms 5 are not in use. In this way, the arms 5 stay at a predetermined position without the active use and subsequent power consumption of the locked actuators.

### Actuator Assembly

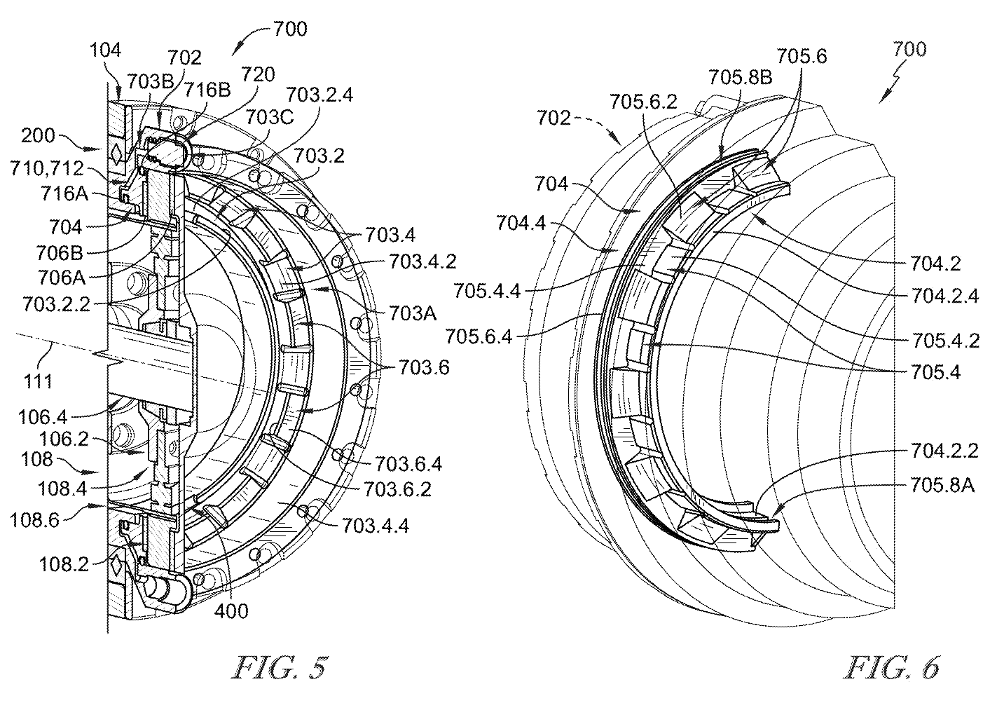

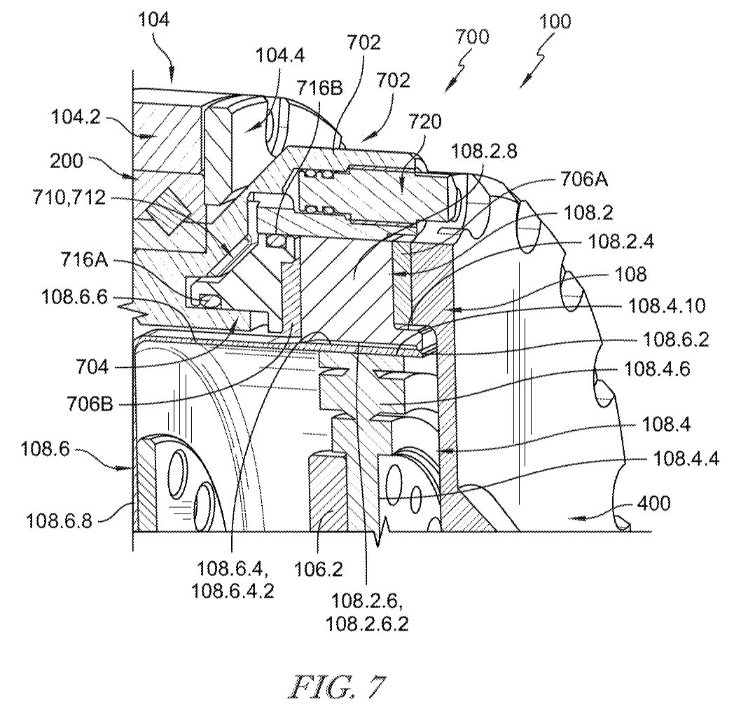

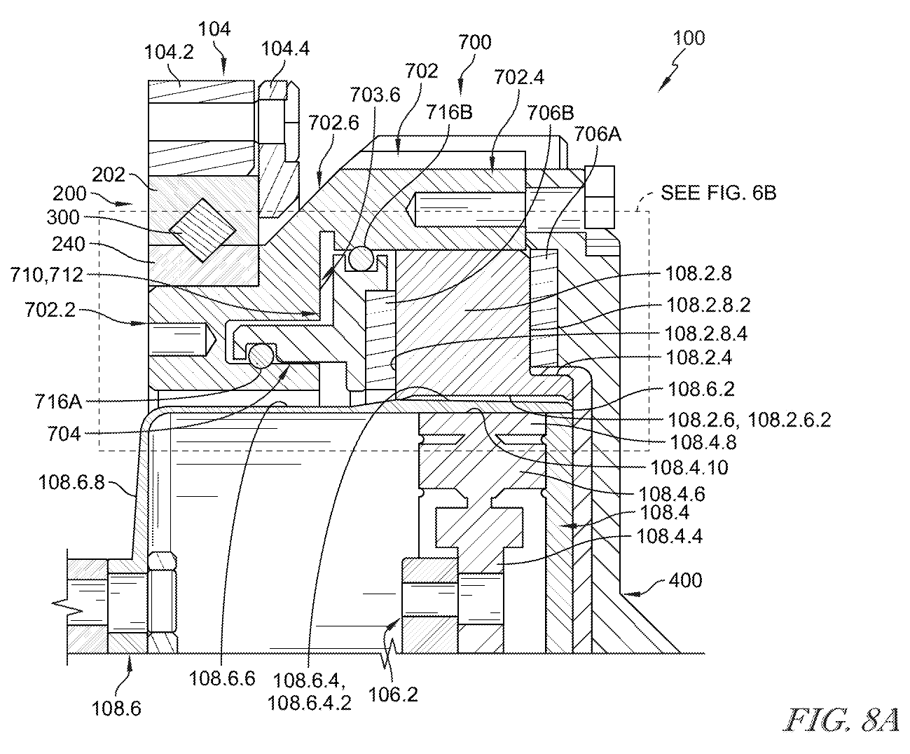

Referring to FIGS. 5-9, the Illustrative actuator assembly 100 includes: (i) a housing 104, (ii) a motor 106, (iii) a hollow-type strain wave gearbox 108, (iv) an actuator bearing 200, (v) an output adapter 400, and (vi) a torque protection device or clutch 700. The motor 106 is arranged within the housing 104. The hollow-type strain wave gearbox 108 includes (i) an internally toothed gear 108.2 (also referred to as a circular spline), (ii) a wave generator 108.4, and (iii) a flexible externally toothed gear 108.6 (also referred to as a flexible spline or flexspline). The wave generator 108.4 is coupled to a shaft or axle (not shown) that extends from the motor 106, the internally toothed gear 108.2 is coupled to an extent of the actuator bearing 200 and the output adapter 400, and the flexible externally toothed gear 108.6 is arranged or positioned between the wave generator 108.4 and the internally toothed gear 108.2. The actuator bearing 200 at least partially surrounds the clutch 700, where an extent of the actuator bearing 200 couples with the clutch 700. The clutch 700 provides a torque protection system to protect the gearbox 108 and devices coupled to the output adapter 400 from being exposed to forces that can break or damage the coupled devices.

The illustrative actuator assembly 100 is provided as an example configuration that includes the disclosed hollow-type strain wave gearbox 108 containing a flexible externally-toothed gear 108.6 having a non-conventional cross-section that reduces the volume occupied in the axial direction and allows the flex spline to displace without increasing the strain to damaging levels. The disclosed flexible externally-toothed gear 108.6 and hollow-type strain wave gearbox 108 may be relied on for other actuator configurations or embodiments to optimize its mechanical performance and design flexibility. For example, the actuator bearing may be formed as a single, integral unit with the actuator housing to reduce the overall part count and simplify assembly. Alternatively, the actuator bearing may be integrally formed with a portion or extent of the internally-toothed gear in the gearbox, thereby effectively combining multiple mechanical functions into a more compact footprint. Although the cross-roller bearing 200 is shown as an illustrative example, the disclosed hollow-type strain wave gearbox 108 may be utilized in configurations with alternative actuator bearing configurations that may incorporate different roller types, including ball bearings, spherical rollers, cylindrical rollers, tapered rollers, needle rollers, barrel rollers, or even magnetic rollers, each offering unique advantages with respect to load-handling capabilities, friction characteristics, and potential overall weight reduction.

The housing 104 is designed to provide structural rigidity for the internal components (e.g., the motor 106, the gearbox 108, actuator bearing 200, etc.) of the actuator assembly 100. The housing 104 may have varying thicknesses, inner diameters, and outer diameters to accommodate the internal components of the actuator assembly 100. The housing 104 may also include mounting features or mounting projections that facilitate mounting of the actuator assembly 100 within the robot 1A-C. As shown in FIGS. 5-9A, the housing 104 includes (i) a main housing 104.2 and (i) a mounting plate 104.4. The main housing 104.2 encases the other internal components of the actuator 100. The mounting plate 104.4 is coupled to the main housing 104.2 over some of the internal components of the actuator 100.

The housing 104 may also include features designed to disperse heat generated by the actuator, especially heat generated from the motor 106. In particular, the actuator housing 104 may include a plurality of projections that extend upward and are spaced apart from one another by a plurality of valleys or recesses. This configuration increases the external surface area of the housing 104 to increase heat dissipation over a housing that lacked the disclosed projections. In other embodiments, the plurality of projections may be omitted in their entirety, or said projection may be omitted and replaced with another structure (e.g., heat pipes) that connect the housing 104 to the structure (e.g., exoskeleton) of the robot 1A-C in order to aid in heat dissipation of said actuator assembly 100.

The housing 104 may be made from any known material, including aluminum alloys, titanium alloys, steel alloys, carbon fiber reinforced polymers (CFRP), glass fiber reinforced polymers (GFRP), polyether ether ketone (PEEK), polyamide (PA), polyphenylene sulfide (PPS), magnesium alloys, brass, nylon. Additionally, said housing 104 may be formed using any known method, including CNC machining, milling, turning, grinding, electrical discharge machining (EDM), stamping, deep drawing, die casting, sand casting, investment casting, injection molding, insert molding, over-molding, compression molding, selective laser sintering (SLS), selective laser melting (SLM), fused deposition modeling (FDM), stereolithography (SLA), direct metal laser sintering (DMLS), binder jetting, laminated object manufacturing (LOM), resin transfer molding (RTM), vacuum infusion, filament winding, sheet metal fabrication, laser cutting, waterjet cutting, plasma cutting, press brake forming, roll forming, extrusion, pultrusion, blow molding, thermoforming, vacuum forming, lost foam casting, hot isostatic pressing (HIP), cold spray additive manufacturing, any combination thereof, and/or any other similar manufacturing type or method.

The housing 104 may be formed as a separate component and coupled to an extent of the robot 1A-C (e.g., its exoskeleton or a component housing) using any known coupling means, which includes mechanical, chemical, or a combination thereof. Examples of said coupling means may include or exclude threaded fasteners (e.g., bolts, screws, studs), projections (e.g., tabs, bosses, barbs), snap-fit connectors (integral snap hooks, living hinges), bayonet mounts, pin-and-hole connections (e.g., clevis pins, hitch pins), press-fit/interference fits, clamp or clip mechanisms, magnets (permanent, electromagnetic), hook-and-loop, rivets (solid, blind/pop, tubular), ball detent connectors, sliding rails, cam locks, toggle clamps, quick-release pins (e.g., detent pins, lynch pins), spring-loaded connectors (e.g., pogo pins, spring clips), wedge locks, dowel pins, ratchet mechanisms, T-slot connectors, twist locks, latches (rotary, draw latches), locking tabs (push-in, fold-over), key-and-keyway (keyed shafts, couplings), set screws (grub screws), collets, locking collars (split collars, clamping collars), adhesives (epoxies, cyanoacrylates, etc.), welding (e.g., MIG, TIG, spot, friction-stir, laser-based, electron beam), shrink fits (thermal interference fit), brazing (silver, brass, etc.), soldering, ultrasonic welding, heat staking, forging (hot or cold), inertial/friction welding, press-brake or folding locks (sheet metal bends forming locking tabs), spiral or snap rings (circlips, retaining rings), buckles (strap-based), puzzle-like interlocks (machined or molded geometries), toggle latches (over-center latch mechanisms), locking wedges, swaging (deforming material into a mating feature), or any combination or hybrid of the above. In other embodiments, said housing 104 may be integrally formed with an extent of the robot 1.

In various alternative embodiments, the actuator housing 104 may incorporate internal cooling channels or cavities—formed during manufacturing or added as separate components—to circulate liquid or gas coolant and enhance heat dissipation, while advanced composite materials (e.g., carbon nanotubes, graphene sheets, or ceramics with tailored thermal conductivity) and external micro- or nano-textured surfaces improve heat transfer without compromising structural integrity. The housing 104 can incorporate phase change materials to absorb and release heat, modular or multi-layered sections for specific thermal management functions, and double-walled designs with either thermally conductive fillers or air gaps for insulation. Smart materials, such as shape memory alloys or bimetallic strips, may alter housing geometry in response to temperature changes, and removable heat sinks or integrated thermoelectric devices can be deployed for active heat pumping or waste-heat energy harvesting. Self-healing materials can automatically enhance conductivity in overheated regions, while integrated piezoelectric elements introduce vibrations to boost convective cooling. Embedded optical fibers or light guides may further channel infrared radiation away from hot spots, and onboard sensors with microcontrollers can monitor and regulate heat distribution in real time.

The output adaptor 400 is configured to be coupled to the next or adjacent component in the robot 1A-C. This coupling between the output adaptor 400 and the next or adjacent component enables the actuator 100 to move said next or adjacent robot component. It should be understood that the housing 104 and/or the output adaptor 400 can act as an exterior housing or exterior component of the robot 1A-C. In other words, the housing or adaptor 104, 400 may be exposed and viewable from the exterior of the robot 1A-C. In other embodiments, the housing and adaptor 104, 400 may be hidden or concealed within an exterior shell or cover.

The axle 106.4 of the motor 106 is coupled to an extent of the gearbox 108 by the motor output coupling 106.2 as shown in FIGS. 5 and 7-9A. The motor may be or may include any type of advanced motor, including but not limited to, brushless DC motors, stepper motors, servo motors, coreless DC motors, synchronous AC motors, asynchronous induction motors, linear motors, piezoelectric motors, direct-drive motors, switched reluctance motors, permanent magnet synchronous motors (PMSMs), axial flux motors, and hybrid stepper motors. These motors may employ rare-earth permanent magnets, such as neodymium-iron-boron (NdFeB) alloys, samarium-cobalt (SmCo) magnets, ferrite magnets, alnico magnets, flexible magnets, bonded rare-earth magnets, and high-temperature permanent magnets, to achieve high torque density and energy efficiency. Motor windings may include high-conductivity copper wire with advanced ceramic or polyimide insulation for superior thermal and electrical performance.

Additionally, to achieve positional accuracy and reliable operation, each motor may be equipped with advanced encoders, which could be optical, magnetic, capacitive, inductive, resistive, piezoelectric, hall-effect, potentiometric, or ultrasonic. These encoders may facilitate sub-millimeter-level accuracy, critical for applications requiring meticulous movement control. To complement positional data, said actuator may include integrated torque sensors that have strain gauges, piezoresistive sensors, magnetoelastic sensors, capacitive sensors, fiber-optic sensors, or rotary transformers. Additionally or alternatively, the actuators may include current sensors, such as Hall-effect sensors, shunt resistors, fluxgate sensors, Rogowski coils, or magnetoresistive sensors. Furthermore, the system may incorporate micro-electromechanical systems (MEMS) gyroscopes and/or accelerometers, which provide additional sensory data related to orientation, angular velocity, and linear acceleration. This sensory integration enhances the robot's ability to navigate complex environments and maintain stability during operation.

The gearbox 108 is configured to reduce the rotational velocity of the motor 106 to enable the output of the gearbox 108 to have a slower rotational velocity than the motor 106. The gearbox 108 may be any one of a strain wave gearbox (e.g., Harmonic Drive), cycloidal reducers, planetary gearboxes, bevel gear systems, parallel shaft helical gear mechanisms, spur gear assemblies, crossed helical gear systems, herringbone gears, hypoid gears, bevel hypoid gears, epicyclic gear trains, and differential gear systems. Additionally, some implementations may incorporate custom gear profiles optimized for torque transfer efficiency, backlash reduction, and noise minimization. The gearbox 108 along with the remaining components of the actuator can provide reduction ratios in the range of 1:50 to 1:1000, and preferably 1:50 to 1:200. In other words, said reduction ratio may be less than 1:1.1. In other embodiments, said reduction ratio may be more than 1:150.

As shown in FIGS. 5-9, the gearbox 108 is a strain wave gearbox that includes: (i) a circular spline or internally toothed gear 108.2, (ii) a wave generator 108.4 coupled to the motor 106, and (iii) a flexspline 108.6 or flexible externally toothed gear 108.6. The strain wave gearbox theory supporting useful operations of the gearbox 108 is based on elastic dynamics and leverages the modulus of elasticity of the metal. While the wave generator 108.4 is driven by the rotation of an input shaft that is coupled to the motor 106, the internally toothed gear 108.2 is coupled to the output adaptor 400. A portion of the flexible externally toothed gear 108.6 is positioned between the internally toothed gear 108.2 and the wave generator 108.4.

The motor can rotate the wave generator 108.4 which can have an elliptical disc shape. The wave generator 108.4 includes an external surface 108.4.10 that is contoured to fit snugly against the inner surface of the flexspline 108.6, ensuring minimal friction and wear. Within said external surface 108.4.10, the wave generator 108.4 includes: (i) an ellipsoidal contoured plug 108.4.4 coupled to the motor output coupler 106.2 that couples input of the gearbox 108 to the motor 106, (ii) a wave generator bearing 108.4.6 mounted on the plug 108.4.4, and (iii) an exterior wall 108.4.8 that is positioned adjacent to an exterior of the wave generator bearing 108.4.6.

The bearing 108.4.6 defines the external surface 108.4.10 of the wave generator 108.4 and is arranged around the plug 108.4.4 to allow the for smooth low friction rotation of the wave generator 108.4 within the flexspline 108.6. Said wave generator bearing 108.4.6 may be made from or include high-carbon bearing steel (e.g. 52100), beryllium copper, stainless steels (e.g. 440C). Additionally, the bearing surfaces may be coated with titanium nitride (TiN) or diamond-like carbon (DLC). Further, said outer ring may be heat-treated, while the inner ring may be press-fitted on the steel cam hub. Moreover, cages or separators may be made of polyamide or similar low-friction plastics to minimize drag and noise. Alternatively, the thin-section ball bearing with a flexible outer ring may be replaced with: (i) a four-point contact ball bearing, (ii) a thin lubricated film or elliptical fluid bearing, (iii) flexible compliant ring or spokes, and/or (iv) two offset standard bearings.

In this embodiment, said wave generator 108.4 is configured to be coupled to motor 106 via a shaft (not shown), and wherein said shaft is designed to transfer the rotatory motion from motor 106 to wave generator 108.4. Said shaft is designed to be hollow and is configured to be aligned with an extent of the opening 108.4.2 to enable passage of a drive shaft, housing lubrication channels, or creating space for cables and sensors of robot 1. However, it should be understood that in other embodiments the wave generator 108.4 and/or the shaft may not be hollow or have openings formed therein.

The flexspline, or flexible externally toothed gear 108.6, includes an extent designed to be positioned between the internally toothed gear 108.2 and the wave generator 108.4 and has a cup-like configuration. In particular, the flexible externally-toothed gear 108.6 includes: (i) an upper edge 108.6.2; (ii) an externally toothed region 108.6.4 extending rearward from the upper edge 108.6.2; (iii) a thin-walled cylindrical region 108.6.6 extending rearward from the toothed region 108.6.4; (iv) a tapered rear wall 108.6.8 coupled to the thin-walled cylindrical region 108.6.6 and being relatively rigid; and (v) a rear output boss 108.6.10 extending inward from the tapered rear wall 108.6.8 and coupled to the shaft of the motor 106. Although the thin-walled cylindrical region 108.6.6 at the open end of the externally toothed gear 108.6 may be relatively flexible, the rear output boss 108.6.10 at the closed side of the externally toothed gear 108.6 may be rigid. The tapered rear wall 108.6.8 increases in thickness from the thin-walled cylindrical region 108.6.6 toward the rear output boss 108.6.10. The rear output boss 108.6.10 may be coupled to the motor 106 using any coupling means, including the methods described above, such as threaded fasteners. The coupling means may extend through openings formed in the rear output boss 108.6.10 of the externally toothed gear 108.6.

The toothed region 108.6.4 includes teeth 108.6.4.2 having profiles configured to optimize engagement between the flexible externally toothed gear 108.6 and the circular spline 108.2. The profile of each tooth 108.6.4.2 includes a curvilinear or S-shaped profile. The S-shaped profile may: (i) help the teeth 108.6.4.2 of the flexspline 108.6 maintain more consistent contact with the circular spline 108.2, thereby improving tooth engagement and distributing loads more evenly along the tooth flank 108.6.4.2.4 and away from the upper extent 108.6.4.2.2 of the tooth 108.6.4.2; (ii) increase torque capacity; (iii) minimize stress concentrations when the flexspline 108.6 flexes, thereby helping prevent premature fatigue failure; (iv) reduce friction and backlash; and (v) improve efficiency. Alternatively, the S-shaped profile may be replaced with an involute tooth profile, a cycloidal tooth profile, a modified involute or hybrid profile, a trapezoidal profile, or another hybrid profile.

The diameter of the flexible externally toothed gear 108.6 is slightly larger than the diameter of the wave generator 108.4, and the flexible externally toothed gear 108.6 has a circular shape, in contrast to the elliptical shape of the wave generator 108.4. Unlike the wave generator 108.4, the flexible externally toothed gear 108.6 is also radially compliant. Differences in form factor, materials, diameters, and shapes between the wave generator 108.4 and the flexible externally toothed gear 108.6 cause the flexible externally toothed gear 108.6 to deform into an elliptical shape when the wave generator 108.4 is inserted into the flexible externally toothed gear 108.6.

The flexspline may be made from high-strength alloy steels, such as 42CrMo4, 34CrNiMo6, 40NiCrMo6, or 40CrNiMoA, and heat-treated to provide the flexspline with a Young’s modulus between 150 and 250 GPa and a tensile strength between 900 and 1,300 MPa. Accordingly, the flexible externally toothed gear 108.6 may be torsionally very stiff. The flexspline may be manufactured using a near-net-shape forging, hot-die forging, or deep-drawing process. The teeth may be formed by hobbing, gear shaping, or electrical-discharge machining (EDM). After formation, the flexspline may be heat-treated using quenching and tempering or a dual-phase heat-treatment process. One or more surface-enhancing coatings may then be applied to increase wear resistance. Alternatively, the flexspline may be made from titanium, such as Ti-6Al-4V, composites, such as carbon-fiber-reinforced epoxy, or a combination of metal and composite materials. For example, the toothed region and central boss may be formed from steel, while the thin cylindrical wall may be formed from a high-strength carbon-fiber composite tube. Further, the flexspline may be manufactured using a metal additive-manufacturing process, including a process using bulk metallic glass, layered alloys, or a metal-matrix composite, or using any other suitable manufacturing method.

The circular spline, or internally toothed gear 108.2, is configured to engage a set of teeth 108.6.4.2 of the flexible externally toothed gear 108.6 along the major axis 111 of the elliptical wave generator 108.4. Specifically, the internally toothed gear 108.2 includes: (i) a cylindrical member 108.2.4 having an internal tooth region 108.2.6, where the internal tooth region 108.2.6 includes teeth 108.2.6.2 configured to interact with the teeth 108.6.4.2; and (ii) a mounting projection 108.2.8 extending radially from the cylindrical member 108.2.4. As shown in the figures, the internal tooth region 108.2.6 extends along the entirety of the inner diameter of the internally toothed gear 108.2.

Due to the elliptical shape of the deformable flexible externally toothed gear 108.6, the flexible externally toothed gear 108.6 engages the internally toothed gear 108.2 only in two regions, owing to the limited height of the teeth 108.2.6.2, 108.6.4.2. The circular spline 108.2 has more teeth 108.2.6.2 than the flexible externally toothed gear 108.6 and is fixed to the gear housing. In particular, the number of teeth 108.6.4.2 of the flexible externally toothed gear 108.6 is 2n teeth fewer than the number of teeth of the rigid internally toothed gear 108.2, where n is a positive integer. Typically, the difference is two teeth, corresponding to n=1. Accordingly, as the meshing position moves in the circumferential direction, relative rotation between the two gears 108.6 and 108.2 occurs according to the difference in the numbers of teeth.

As shown in FIGS. 5-9, when the wave generator 108.4 is rotated, the meshing position between the external teeth 108.6.4.2 of the flexible externally toothed gear 108.6 and the internal teeth 108.2.6.2 of the rigid internally toothed gear 108.2 moves in the circumferential direction. For every 180-degree clockwise rotation of the wave generator 108.4, the external teeth 108.6.4.2 of the flexible externally toothed gear 108.6 advance counterclockwise by one tooth relative to the internal teeth 108.2.6.2 of the rigid internally toothed gear 108.2. Each complete 360-degree clockwise rotation of the wave generator 108.4 therefore causes the external teeth 108.6.4.2 of the flexible externally toothed gear 108.6 to move counterclockwise by two teeth from their original position relative to the internal teeth 108.2.6.2 of the rigid internally toothed gear 108.2. Because the gear teeth remain fully engaged in regions along the major axis 111, the strain wave gearbox 108 is configured to exhibit little or no backlash.

The wave generator 108.4 may be coupled to the motor 106. As the motor 106 rotates the wave generator 108.4, the flexspline teeth engaged with the internal teeth of the circular spline 108.2 gradually change position. The major axis 111 of the elliptical flexspline 108.6 rotates with the wave generator 108.4, causing the tooth-meshing regions to revolve about the center at the same rate as the shaft of the wave generator 108.4. The flexspline 108.6 has fewer external teeth than the circular spline 108.2 has internal teeth. Accordingly, for each complete rotation of the wave generator 108.4, the flexspline 108.6 rotates slightly backward relative to the circular spline 108.2. The rotation of the wave generator 108.4 therefore produces a substantially slower rotation of the flexspline 108.6. In the illustrated embodiment, the flexspline 108.6 may have 60 teeth, and the circular spline 108.2 may have 62 teeth. Because the flexspline 108.6 has two fewer teeth than the circular spline 108.2, the flexspline 108.6 rotates backward by two tooth positions for each complete rotation of the wave generator 108.4.

The actuator assembly 100 also includes an actuator bearing 200, which may be a cross-roller bearing 200. This actuator bearing 200 is coupled to an extent of the housing 104 and the clutch 700 as shown in FIGS. 5-9. The cross-roller bearing 200 is designed to have a high load capacity, low angular deviation, and long service life, making it ideal for the demanding requirements of humanoid robotics. Said cross-roller bearing may include bearing housings constructed using advanced materials like carbon-fiber-reinforced polymers (CFRPs), fiberglass-reinforced polymers (FRPs), metal alloys, polyetheretherketone (PEEK), thermoplastic composites, and ultra-high-molecular-weight polyethylene (UHMWPE). Additionally, the manufacturing processes for CFRPs, such as filament winding or automated fiber placement, allow for precise control over fiber orientation, further optimizing the mechanical performance of the housings. The bearings themselves can be fabricated from, include, or processed using high-grade steel alloys (e.g., AISI 52100, M50, or 440C stainless steel), high-performance nickel-based superalloys (e.g., Inconel 718 or Hastelloy), cobalt-based alloys (e.g., Stellite), advanced ceramics (e.g., alumina or zirconia-based composites), and polymer matrix composites reinforced with carbon or aramid fibers. These materials may also benefit from advanced heat treatments (e.g., vacuum hardening or cryogenic treatment), surface engineering processes (e.g., ion implantation or physical vapor deposition), or specialized coatings.

As shown in FIGS. 5-9, the cross-roller bearing 200 includes: (i) an outer race 202, (ii) an inner race 240, and (iii) a cross-roller assembly 300. The outer race 202 is designed to fix the outer race 202 in place and couple it to the housing 104. The inner race 240 is designed to rotate with the actuator's movement and facilitates the connection to the internally toothed gear 108.2 and the output adaptor 400. The cross-roller assembly 300 is a pivotal component of the cross-roller bearing 200, designed to facilitate the transfer of loads and motion between the inner and outer races 240 and 202.

The outer race 202 and/or the inner race 240 may be a solid, unitary structures. Alternatively, one or both of the races 202, 240 may be split into two portions, wherein said portions include an upper portion and a lower portion. Said upper and lower portions can then be coupled to one another using any known removable coupling means (e.g., threaded fasteners or any above-described removable member) to facilitate installation. In a further alternative, the races 202, 240, rollers 310, 320, and optional spacers may be additively manufactured such that they are printed as a single structure.

To further optimize performance, the rolling elements of the bearings may be composed of advanced ceramic materials (e.g., silicon nitride, tungsten carbide, or zirconia), sapphire, or composite materials combining ceramic with metal or polymer matrices. In another embodiment, the assembly may incorporate cylindrical roller bearings, angular contact ball bearings, or hybrid bearings that combine steel races with ceramic rolling elements. Additionally, spherical roller bearings, tapered roller bearings, needle roller bearings, magnetic bearings, or hybrid or combinations thereof. Cutting-edge manufacturing techniques, including additive manufacturing methods like selective laser melting (SLM), could be employed to create complex bearing geometries. These geometries may integrate features such as internal cooling channels, lubrication reservoirs, or textured surfaces to enhance lubrication retention and minimize wear.

The incorporation of such features allows for improved thermal management, reduced friction, and consistent lubrication distribution, even under challenging operating conditions. Additive manufacturing also enables the production of customized bearing designs with minimal material waste, aligning with sustainable manufacturing practices. In addition to additive manufacturing, other advanced processes like precision machining, laser hardening, or chemical vapor deposition (CVD) coatings may be applied to enhance the surface properties of the bearings. These techniques can improve wear resistance, reduce friction, and provide protection against corrosion, further extending the operational life of the components. The integration of smart sensors within the bearing housing is another potential enhancement, allowing for real-time monitoring of parameters such as temperature, vibration, and load. This data can be used to predict maintenance needs and prevent unexpected failures, ensuring optimal performance and reliability in critical applications.

In some embodiments, the wall thickness of the races, the size of the bearings (e.g., length and diameter), number of bearings, size and configuration of the spacers, materials, lubricants, manufacturing methods, coatings, design (e.g., solid or split portion races), installation methods, and/or configurations may be selected based upon: (i) the performance aspects (e.g., torque and/or speed) of the actuator, (ii) forces experienced by said actuator and/or its output (e.g., axial, radial, and/or moment), and/or (iii) a combination thereof. For example, certain high-speed actuator applications may benefit from reducing the bearing diameter and increasing the total number of bearings to minimize rotational inertia and frictional losses. Furthermore, in such high-speed environments, specialized lubricants (e.g., high-temperature grease or synthetic oils) and low-friction coatings (e.g., diamond-like carbon or tungsten disulfide) may be employed to reduce heat generation and extend bearing life. In contrast, slower-speed applications that encounter comparatively lower rotational speeds but higher load requirements may rely on bearings of larger diameter and increased wall thickness in the races to withstand significant radial, axial, and/or moment loads without premature wear or deformation. In some embodiments, the spacers may also be formed from materials with higher compressive strength (e.g., hardened steel or ceramic) when the actuator is anticipated to encounter high shock loads or abrupt directional changes. Additionally, to address corrosive environments or extreme temperature ranges, bearings and races may be formed from stainless steel alloys (e.g., 440C), ceramics (e.g., silicon nitride), or other suitable materials that exhibit desired chemical resistance or thermal stability.

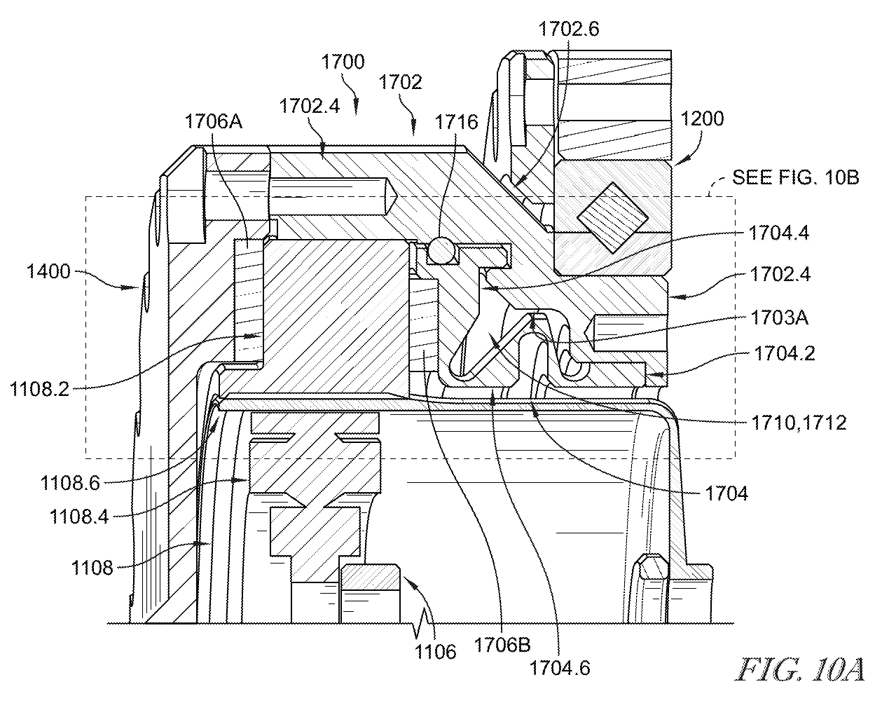

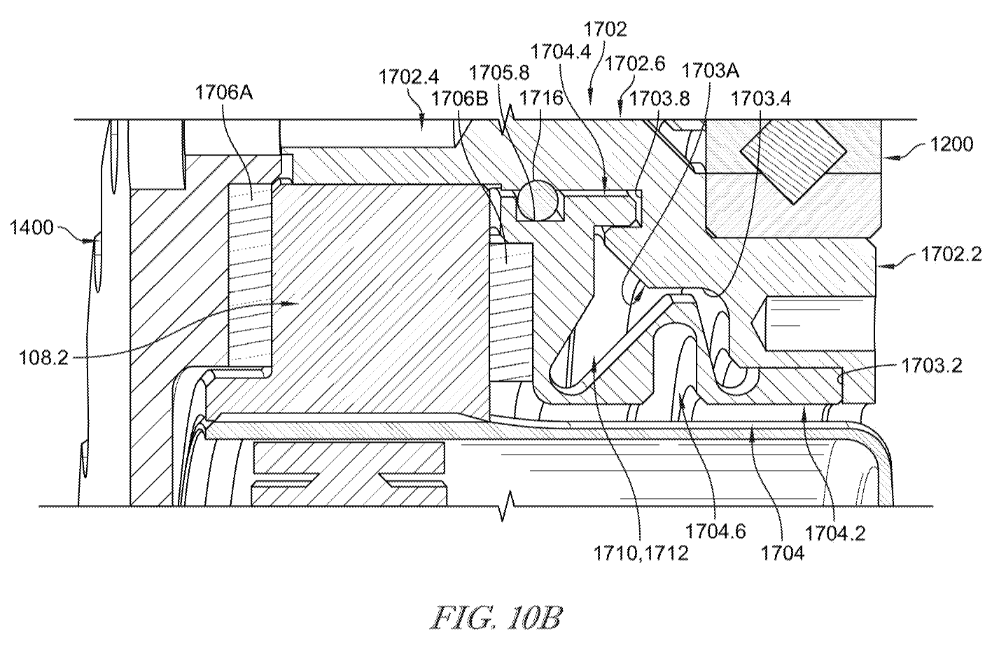

The clutch or torque protection device 700 is arranged between the gearbox 108 and the actuator bearing 200 as shown in FIGS. 5-9. The circular spline or output ring 108.2 of the gearbox 108 transmits power to the clutch 700 which is coupled to the output adaptor 400. The clutch 700 prevents torque above a predetermined value from being transmitted to other components of the actuator assembly 100 (e.g., the actuator housing 104, the output adaptor 400, the actuator bearing 200, etc.) to protect the gearbox 108 and the other components of the actuator assembly 100 connected to the clutch 700 in the event that the rotational torque transmitted from the motor 106 exceeds a design strength of different components. FIGS. 5-9 show a first embodiment of the clutch 700 included in the actuator assembly 100. FIGS. 10A and 10B show a second embodiment of the clutch 1700 included in the actuator assembly 1100.

FIGS. 5-9 illustrate an upper portion (e.g., 1/4) of a first embodiment the clutch 700 for the actuator assembly 100. The clutch 700 includes: (i) an outer body 702, (ii) an inner body 704, (iii) at least one clutch friction plate 706A, 706B, (iv) a fluid chamber 710, (v) fluid 712 in the fluid chamber 710, (vi) seals 716A, 716B, and (vii) an adjustment mechanism 720. The outer body 702 surrounds the gearbox 108 (e.g., the circular spline 108.2, the wave generator 108.4, and the flexspline 108.6). A first end of the outer body 702 is coupled to the inner race 240 of the actuator bearing 200, while a second end of the outer body 702 is coupled to the output adaptor 400 so that the output adaptor 400 rotates therewith. The inner body 704 is positioned within the outer body 702 to define the fluid chamber 710 therebetween. The at least one clutch friction plate 706A, 706B, illustratively two clutch plates 706A, 706B as shown in FIGS. 5-9, is configured to transfer the torque to the outer body 702 so that the outer body 702 rotates with the gearbox 108 and the motor 106. The seals 716A, 716B are arranged between outer and inner bodies 702, 704 to seal the fluid chamber 710 from the rest of the actuator assembly 100. The adjustment mechanism 720 is configured to pressurize the fluid 712 in the fluid chamber 710 so that the inner body 704 is pressed towards the output ring 108.2 and the output ring 108.2 is pressed towards the clutch friction plate 706A.

During operation of the actuator assembly 100, the motor 106 drives rotation of the gearbox 108 and thus the circular spline or output ring 108.2 of the gearbox 108. The output ring 108.2 of the gearbox 108 transmits this power to the clutch 700 which is coupled to the output adaptor 400. The friction between the first clutch friction plate 706A and the output ring 108.2 causes the outer body 702 to rotate at the same rotational velocity as the gearbox 108. Once the rotational torque applied by the motor 106 to the gearbox 108 exceeds a predetermined torque, the rotational torque causes the first clutch friction plate 706A to slide against the output ring 108.2 of the gearbox 108. As a result, the torque from the gearbox 108 is not transmitted to the outer body 702 and thus the output adaptor 400.

The outer body 702 may have a complex geometry that is configured to abut: (i) the bearing 200, (ii) the inner body 704, and (iii) the output ring 108.2 of the gearbox 108 as shown in FIGS. 5-9. Said outer body 702 extends from a first end coupled to the actuator bearing 200 to a second end coupled to the output adaptor 400. As shown in FIGS. 5-9, the outer body 702 includes: (i) an inner section 702.2 defining the first end; (ii) an outer section 702.4 defining the second end; and (iii) an interconnecting section 702.6 extending between and interconnecting the inner section 702.2 and the outer section 702.4. The inner section 702.2 is positioned radially between: (i) the housing 104 and the actuator bearing 200; and (ii) an extent of the flexspline 108.6 of the gearbox 108. The inner section 702.2 extends around the flexspline 108.6 and defines a first inner diameter of the outer body 702. The outer section 702.4 is positioned radially outward of the output ring 108.2 of the gearbox 108 and extends around the output ring 108.2 to define a second inner diameter of the outer body 702. The second inner diameter is greater than the first inner diameter. The interconnecting section 702.6 extends both axially and radially between the inner section 702.2 and the outer section 702.4.

As shown in FIGS. 5-9, the outer body 702 is also shaped to include an inner-body receiving space 703A that is designed to receive the inner body 704 of the clutch 700. The inner-body receiving space 703A has (i) an annular groove 703.2 and (ii) a plurality of receivers 703.4 that are spaced apart circumferentially about the axis 111 to define a plurality of projections or teeth 703.6 therebetween. The annular groove 703.2 extends circumferentially about the axis 111, and the receivers 703.4 open to the annular groove 703.2 at locations spaced circumferentially about the axis 111.

As shown in FIGS. 5-9, the annular groove 703.2 has: (i) a lower groove surface 703.2.2 that is designed to abut the inner body 704 and one of the seals 716 and (ii) a rear groove surface 703.2.4 that is designed to form an extent of the rear wall of the fluid chamber 710. The lower groove surface 703.2.2 and the rear groove surface 703.2.4 each extend circumferentially about the axis 111. The rear groove surface 703.2.4 extends radially outward from the lower groove surface 703.2.2 and faces an extent of the inner body 704. As shown in FIGS. 5-9, the inner section 702.2 of the outer body 702 defines the lower groove surface 703.2.2 and the rear groove surface 703.2.4.

As shown in FIGS. 5-9, each notch or receiver 703.4 has a wedged shaped configuration with: (i) the lower surface 703.2.2 that is designed to abut the inner body 704 and one of the seals 716A, (ii) the rear groove surface 703.2.4 and a rear receiver surface 703.4.2 that are designed to form an extent of the rear wall of the fluid chamber 710, and (iii) an upper surface 703.4.4 that is designed to abut the inner body 704 and the other seal 716B. The rear receiver surface 703.4.2 only extends partway about the axis 111. As shown in FIGS. 5-9, the interconnecting section 702.6 defines the rear receiver surface 703.4.2 and outer section 702.4 defines the upper surface 703.4.4.

As shown in FIGS. 5-9, each projection 703.6 has: (i) an axial projection surface 703.6.2 that is designed to face an extent of the inner body 704 and (ii) a radial projection surface 703.6.4 that is designed to face another extent of the inner body 704. The radial projection surface 703.6.4 extends radially from the axial projection surface 703.6.2 out to the upper surface 703.4.4. The axial and radial surfaces 703.6.2, 703.6.4 form another extent of the rear wall of the fluid chamber 710.

When the inner body 704 is arranged or received in the inner-body receiving space 703A of the outer body 702, the fluid chamber 710 is formed therebetween. As shown in FIGS. 5-9, the outer body 702 also includes a channel 703B that is fluid communication with the fluid chamber 710 formed between the outer and inner bodies 702, 704 and the adjustment mechanism 720. To enable this fluid communication, the outer body 702 is designed to receive an extent of the adjustment mechanism 720. In particular, the outer body 702 may include a threaded extent 703C (e.g., a bore hole 703C) that is designed to receive a threaded extent of the adjustment mechanism 720. The channel 703B extends from the fluid chamber 710 radially into the interconnecting section 702.6 and axially into the outer section 702.4 to the bore hole 703C that receives the adjustment mechanism 720.

Said inner body 704 extends between a first end engaged with the first seal 716A that seals against the lower surface 703.4.2 and a second end engaged with the second seal 716B that seals against the upper surface 703.4.6. The inner body 704 includes: (i) an inner ring section 704.2 that defines the first end, (ii) an outer ring section 704.4 that defines the second end, and (iii) a plurality of projections or teeth 705.6 that each extend from the inner and outer ring sections 704.2, 704.4 as shown in FIGS. 5-9. The inner ring section 704.2 extends circumferentially about the axis 111 and is received within the annular groove 703.2 of the inner-body receiving space 703A. The outer ring section 704.4 extends radially from the inner ring section 704.2 and circumferentially about the axis 111. The projections 705.6 are spaced apart circumferentially about the axis 111 and each projection 705.6 extends axially and radially between the inner and outer ring sections 704.2, 704.4.

As shown in FIGS. 5-9, the plurality of projections or teeth 705.6 are circumferentially spaced about the axis 111 to define a plurality of receivers 705.4 therebetween. Each receiver 705.4 of the inner body 704 is configured to receive a corresponding projection 703.6 of the outer body 702. Likewise, when the inner body 704 is positioned within the inner-body receiving space 703A of the outer body 702, the projections 705.6 of the inner body 704 are received in the receivers 703.4 of the outer body 702. In this arrangement, the projections or teeth 705.6 of the inner body 704 are positioned adjacent to or otherwise interact with the projections 703.6 of the outer body 702. The resulting mutual interlocking of the circumferential teeth transfers torque between the inner body 704 and the outer body 702 while permitting axial translation of the inner body 704 toward the output ring 108.2 as the fluid chamber 710 is pressurized. Other suitable arrangements for transferring torque or energy between these adjacent components may also be used

As shown in FIGS. 5-9, the inner ring section 704.2 includes: (i) a lower inner-ring surface 704.2.2 configured to abut the lower groove surface 703.2.2; and (ii) a forward inner-ring surface 704.2.4 configured to define a portion of the forward wall of the fluid chamber 710. The lower inner-ring surface 704.2.2 and the forward inner-ring surface 704.2.4 each extend circumferentially about the axis 111. The forward inner-ring surface 704.2.4 extends radially outward from the lower inner-ring surface 704.2.2 and faces the rear groove surface 703.2.4 of the outer body 702.

As shown in FIGS. 5-9, each projection 705.6 has a wedge-shaped configuration corresponding to the rear receiver surface 703.4.2 of the outer body 702. The projection 705.6 includes: (i) the lower inner-ring surface 704.2.2, configured to abut the lower groove surface 703.2.2; (ii) the forward inner-ring surface 704.2.4 and a forward projection surface 705.6.2, configured to define portions of the forward wall of the fluid chamber 710; and (iii) an upper surface 705.6.4, configured to abut the upper surface 703.4.4 of the outer body 702

As shown in FIGS. 5-9, each notch or receiver 705.4 includes: (i) an axial receiver surface 705.4.2 configured to face the axial projection surface 703.6.2 of the projection 703.6; and (ii) a radial receiver surface 705.4.4 configured to face the radial projection surface 703.6.4. The radial receiver surface 705.4.4 extends radially from the axial receiver surface 705.4.2 to the upper surface 705.6.4. Together, the axial receiver surface 705.4.2 and the radial receiver surface 705.4.4 define another portion of the rear wall of the fluid chamber 710

As shown in FIGS. 5-9, the inner body 704 also includes seal receivers or grooves 705.8A, 705.8B. In the illustrated embodiment, each ring section 704.2, 704.4 includes a corresponding seal receiver or groove 705.8A, 705.8B. The inner ring section 704.2 includes an inner or lower seal receiver 705.8A configured to receive a portion of the inner or lower seal 716A. The outer ring section 704.4 includes an outer or upper seal receiver 705.8B configured to receive a portion of the outer or upper seal 716B...

As shown in FIGS. 5-9, the fluid chamber 710 is formed between the outer body 702 and the inner body 704 when the inner body 704 is positioned within the inner-body receiving space 703A of the outer body 702. The fluid chamber 710 may be bounded by: (i) rear walls or surfaces of the outer body 702, including the rear groove surface 703.2.4, rear receiver surface 703.4.2, axial projection surface 703.6.2, and radial projection surface 703.6.4; (ii) forward walls or surfaces of the inner body 704, including the forward inner-ring surface 704.2.4, forward projection surface 705.6.2, axial receiver surface 705.4.2, and radial receiver surface 705.4.4; (iii) the seals 716; (iv) the channel 703B formed in the outer body 702; and (v) a rear portion of the adjustment mechanism 720. In the illustrated embodiment, the fluid chamber 710 extends circumferentially about the axis 111 and is configured to be filled with fluid 712. The fluid 712 may be any suitable fluid, including a known hydraulic fluid.

Consistent with this sealing arrangement, a defined clamping load on the rotating friction interface may be maintained by employing the captive incompressible fluid 712 sealed within the annular fluid chamber 710 by O-ring seals 716A, 716B carried in seal receivers 705.8A, 705.8B on the inner body 704. Because the fluid 712 is an incompressible liquid, its volumetric response to axial motion of the inner body 704 relative to the outer body 702 governs the pressure state within the chamber. The captive-fluid arrangement enables the entire torque protection apparatus to rotate as a unit with the output adaptor 400.

As shown in FIGS. 5-9, the clutch 700 includes: (i) an inner or lower seal 716A; and (ii) an outer or upper seal 716B, which seal the fluid chamber 710 between the outer body 702 and the inner body 704. The inner seal 716A is at least partially received in the inner or lower seal receiver 705.8A, between the lower surface 703.4.2 of the outer body 702 and the inner body 704. The outer seal 716B is at least partially received in the outer or upper seal receiver 705.8B, between the upper surface 703.4.6 of the outer body 702 and the inner body 704. The seals 716A, 716B are positioned in the respective seal receivers 705.8A, 705.8B so that they move with the inner body 704. As shown in FIGS. 5-9, the seals 716A, 716B are O-ring seals extending circumferentially around the inner body 704 within the respective seal receivers 705.8A, 705.8B. In other embodiments, the seals 716A, 716B may be any other suitable type of seal. Additional or fewer seals may also be used.

The output ring 108.2 can have a disc configuration with planar surfaces 108.2.8.2, 108.2.8.4 that are positioned between at least one clutch plate 706A, 706B. As shown in FIGS. 5-9, the output ring 108.2 is configured to be compressed between clutch plates 706A, 706B so that there is normally no relative movement between the output ring 108.2 and the clutch friction plates 706A, 706B. Because said output ring 108.2 is fixed between the clutch friction plates 706A, 706B in this normal state, the outer body 702 of the clutch 700 and the output adaptor 400 will rotate at the same rotational velocity as the output ring 108.2 of the gearbox 108. The clutch friction plates 706A, 706B may be made of organic, ceramic, semi-metallic materials, or other suitable brake pad materials. The gearbox output ring 108.2 can be made of aluminum.

As shown in FIGS. 5-9, the clutch 700 of the illustrated embodiment includes: (i) a first clutch friction plate 706A; and (ii) a second clutch friction plate 706B. The first clutch friction plate 706A is positioned on a first planar disc surface 108.2.8.2 of the output ring 108.2, axially between the output adaptor 400 and the output ring 108.2. Because of this positioning, the first clutch friction plate 706A is fixed in place. The second clutch friction plate 706B is positioned on a second planar disc surface 108.2.8.4 of the output ring 108.2, opposite the first planar disc surface 108.2.8.2 and axially between the inner body 704 and the output ring 108.2. The second clutch friction plate 706B is configured to slide axially within the outer body 702. For example, when fluid 712 in the fluid chamber 710 urges the inner body 704 outward, away from the motor 106 and toward the output adaptor 400, the inner body 704 may correspondingly urge the second clutch friction plate 706B in the same direction. In some circumstances, when motor torque exceeds a clutch breakaway-torque threshold, the second clutch friction plate 706B may slightly deform or slide inward, toward the motor 106 and away from the output adaptor 400. In an alternative embodiment, the first clutch friction plate 706A may be omitted.

The adjustment mechanism 720 is configured to pressurize the fluid 712 within the fluid chamber 710 to: (i) urge the inner body 704 toward the output ring 108.2; (ii) urge the inner body 704 against the second clutch friction plate 706B; and (iii) urge the first planar disc surface 108.2.8.2 of the output ring 108.2 against the first clutch friction plate 706A. Friction between the first clutch friction plate 706A and the first planar disc surface 108.2.8.2 causes the outer body 702, and therefore the output adaptor 400, to rotate at substantially the same rotational velocity as the gearbox 108 and motor 106 while the fluid 712 is pressurized. The outer body 702 continues to rotate with the gearbox 108 until torque transmitted from the motor axle to the gearbox 108 exceeds a predetermined torque threshold. Once the threshold is exceeded, either: (i) the first clutch friction plate 706A slides relative to the first planar disc surface 108.2.8.2; or (ii) the first and second clutch friction plates 706A, 706B slide relative to their respective planar disc surfaces 108.2.8.2, 108.2.8.4. This relative sliding allows the clutch 700 to slip and thereby limit torque transmitted to the output adaptor 400.

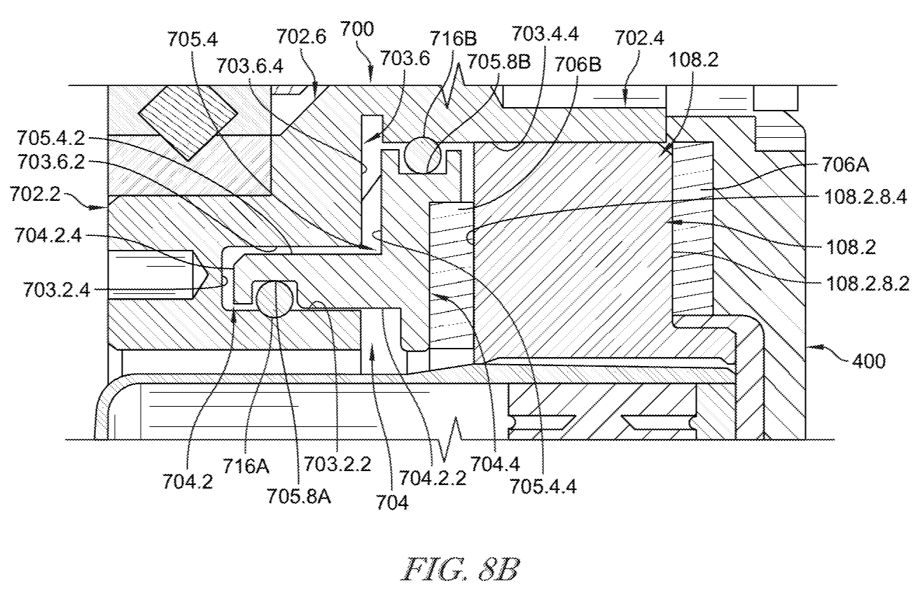

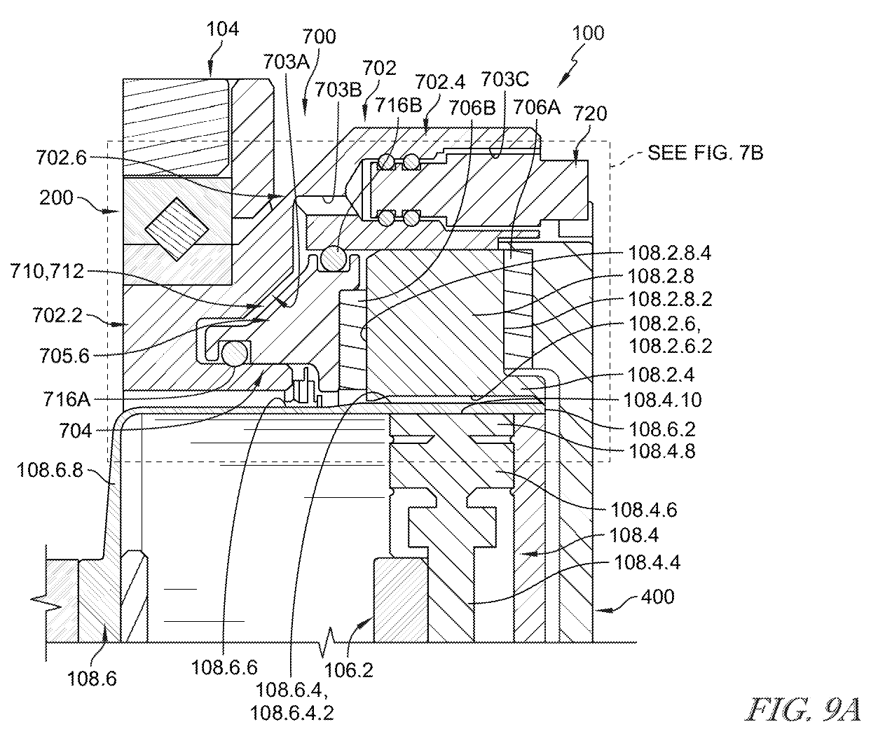

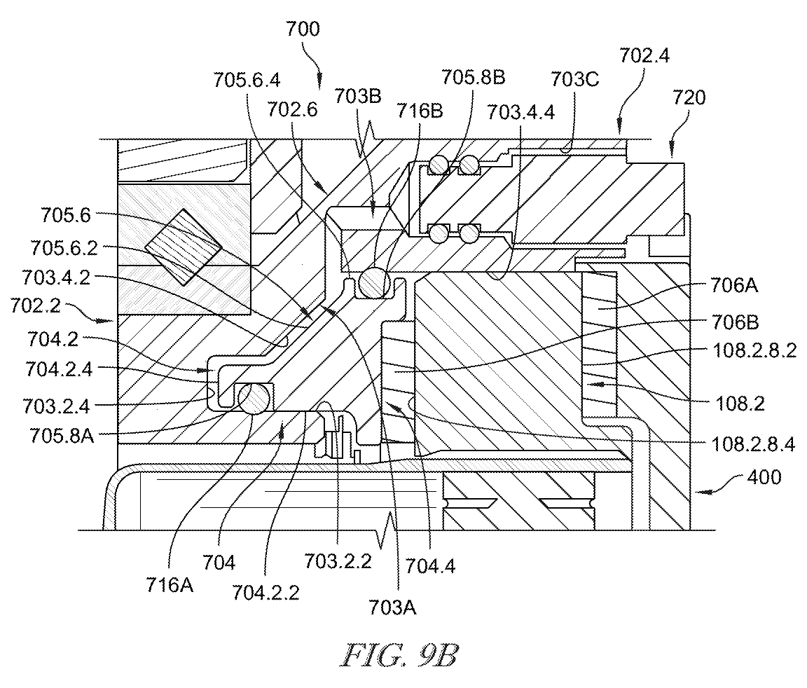

The adjustment mechanism 720 is coupled to the outer body 702 and designed to adjust and control the pressure applied by the inner body 704 on the clutch plates 706A, 706B, which in turn controls the pressure applied on the output ring 108.2. As shown in FIGS. 7, 9A, and 9B, the adjustment mechanism 720 may be one or both of a hydraulic adjustment piston or a gas bleed piston that has external threads and is designed to be threaded into the bore 703C (e.g., a pressure or bleed bore) in the outer body 702. The outer body 702 includes cooperatively dimensioned internal threads. An inner portion of the adjustment mechanism 720 has one or more O-ring seals 720.2 that slide against a smooth inner diameter of the bore 703C in the outer body 702.

The bore 703C is filled with fluid 712 positioned within the fluid chamber 710 by way of the internal passageway or channel 703B. The pressure of the fluid 712 within the fluid chamber 710 can be increased by screwing the adjustment mechanism 720 into the threaded bore 703C in the outer body 702. The movement of the adjustment mechanism 720 into the outer body 702 reduces the total volume of the fluid chamber 710 and internal passageways which increases the pressure within said fluid chamber 710. Conversely, the fluid 712 pressure can be decreased by screwing the adjustment mechanism 720 out of the threaded bore 703C in the outer body 702. The movement of the adjustment mechanism 720 out of the outer body 702 increases the total volume of the fluid chamber 710 and internal passageways which decreases the pressure. Because the fluid 712 is incompressible liquid, a small movement of the adjustment mechanism 720 into or out of the outer body 702 can result in a significant change in fluid pressure.

In some implementations, to increase the reliability of the pressure-to-volume relationship of the fluid remains reliable, a gas bleed piston may be mounted in a bleed bore in the outer body 702, together with a second passageway from the bleed bore to the interior volume between the inner body 704 and the outer body 702. The gas bleed piston is sealed against the bleed bore in the outer body 702 when all gas has been removed from the fluid chamber 710. Providing a bleed bore separate from the pressure bore 703C permits the fluid chamber 710 to be filled and degassed independently of the setpoint adjustment made by the hydraulic adjustment piston 720, reducing the likelihood that the pressure-to-torque calibration is disturbed by residual gas that may otherwise compress under load and cause the breakaway torque to drift.

Still further, in some implementations, a pressure gage can be coupled to the fluid chamber 710, the channel 703B, the bore 703C, or another connected internal passageway so that the pressure can be detected and measured. The adjustment mechanism 720 may adjust the pressure of the fluid 712 based on the feedback from the pressure gage. For example, in some implementations, a pressure adjustment motor may be coupled to the adjustment mechanism 720, allowing a control system of the robot 1A-C to adjust the fluid pressure, and thereby the breakaway torque, without manual user intervention.

Still further, another alternative implementation may employ dual adjustment mechanisms, either instead of or in addition to the implementations described above. For example, the outer body 702 of the clutch 700 may include a first pressure bore and a second pressure bore. Each pressure bore may be in fluid communication with the fluid chamber 710 through a respective, separate passageway, such as the channel 703B described herein. The first pressure bore may receive a coarse hydraulic adjustment piston having a relatively large effective cross-sectional area, while the second pressure bore may receive a fine hydraulic adjustment piston having a relatively smaller effective cross-sectional area. Because each piston’s contribution to fluid-volume displacement, and thus to fluid-pressure adjustment, is related to the product of the piston’s effective cross-sectional area and its axial displacement within the corresponding bore, the coarse piston may produce a substantially larger pressure increment per unit of axial travel than the fine piston. Accordingly, the coarse hydraulic adjustment piston may be configured for relatively large and infrequent setpoint changes, such as factory calibration during initial assembly, recalibration after replacement of the gearbox 108, or wear-based pressure derating consistent with the control-system wear-tracking functionality described herein. The fine hydraulic adjustment piston may be configured for continuous, closed-loop micro adjustment during operation of the humanoid robot 1A–1C, including temperature compensation for thermal expansion of the fluid 712 and dynamic impedance modulation commanded by the robot control system. Both pistons communicate hydraulically with the same fluid chamber 710, such that the fluid pressure at any given time is determined cumulatively by the axial positions of both pistons.

In an alternative embodiment, the coarse and fine pressure bores are arranged concentrically within a single stepped bore formed in the outer body 702, wherein the coarse piston occupies the larger-diameter outer step and the fine piston is coaxially received within the smaller-diameter inner step, reducing the angular footprint on the outer body 702 and preserving the circumferential space available for the interlocking projection 703.6 and receivers 703.4.

The clutch or torque protection device 700 is configured to protect the gearbox 108 and devices coupled to the output adapter 400 from being exposed to forces that can break or damage the coupled devices. The clutch 700 can normally transmit the full torque power that the motor 106 applies to the axle through the gearbox 108 to the clutch 700. In this normal state, the motor 106 does not exceed a clutch breakaway torque value. In this state, the fluid 712 pushes the inner body 704 towards the output ring 108.2. The outwardly directed force that is applied on the inner body 704 causes a clamping force to be applied between the clutch friction plates 706A, 706B. In other words, the fluid 712 presses the inner body 704 against the second clutch friction plate 706B on the second planar disc surface 108.2.8.4 and presses the first planar disc surface 108.2.8.2 of the output ring 108.2 against the first clutch friction plate 706A. Said clamping force applies pressure against the output ring 108.2 to create enough friction to lock the output ring 108.2 to the output adaptor 400.

When the torque of the motor 106 exceeds a clutch breakaway torque value, the friction associated with the clamping force via the clutch friction plates 706A, 706B is overcome. When said friction is overcome, the gearbox output ring 108.2 can slide against one or both of the clutch friction plates 706A, 706B. If the torque applied to the clutch 700 is reduced below the set breakaway torque value, then the gearbox output ring 108.2 can stop sliding in relation to the clutch friction plates 706A, 706B. This enables the outer body 702 and the output adaptor to rotate at the full rotational torque of the gearbox 108.

The clutch breakaway torque value is adjustable and can be set to prevent the motor 106 from transmitting torque above the design strength of the gearbox 108 and components attached output adapter 400. Thus, because the design strengths of the gearbox 108 and the components attached to the outer body 702 will generally be known, the clutch breakaway torque may be set to a value that is below all of these component design strengths. In one representative implementation, for a gearbox 108 having a maximum torque rating of 300 Nm, the clutch breakaway torque may be set within a range of 250 Nm to 280 Nm so the gearbox 108 does not reach its maximum torque rating during operation. The clutch breakaway torque is proportional to the pressure against the inner body 704 that controls the pressure of the clutch plates 706A, 706B against the output ring 108.2. A higher pressure will result in a higher breakaway torque and a lower pressure will result in a lower breakaway torque. In different embodiments, various adjustment mechanisms can be used to control the pressure of the clutch plates 706A, 706B against the output ring 108.2.

The break-away slip torque for the clutch 700 can be calculated based on the pressure of the fluid 712. The equation for the break-away slip torque is ST = R*μ*P*A, where ST is the maximum torque that is transmitted through the clutch 700, R is the effective radius of the clutch fiction plate 706A, 706B that rests against the gearbox output ring 108.2, μ is the coefficient of friction between the clutch friction plate 706A, 706B and the gearbox output ring 108.2, P is the pressure of the fluid 712, and A is the effective area of the inner body 704. The effective radius R is a distance related to the output ring 108.2 and the clutch friction plate(s) 706A, 706B. The effective radius R can be determined by (l) the outer diameter of the output ring 108.2 and (2) the width of the contact zone of the clutch friction plate(s) 706A, 706B on the output ring 108.2. In general, the effective radius R lies approximately in the middle of the contact zone of the clutch friction plate(s) 706A, 706B on the output ring 108.2. The static coefficient of friction of the clutch friction plates 706A, 706B against the gearbox output ring 108.2 can be between 0.4 and 0.55. A higher number represents more friction between the friction plate 706A, 706B and the output ring 108.2 and a lower number represents less friction between the friction plate 706A, 706B and the output ring 108.2. The effective area of inner body 704 can be calculated from the physical dimensions of the inner body 704. In the illustrated embodiment, the inner body 704 can be an annular structure with seals 716A, 716B that keep the fluid 712 within a designated fluid 712 volume when the inner body 704 slides within the outer body. The inner body 704 effective area A can be π*(Rₒᵤₜₑᵣ - Rᵢₙₙₑᵣ)² where Rₒᵤₜₑᵣ is the radius of the O-ring seal 716A, 716B on the outer diameter of the inner body 704 and Rᵢₙₙₑᵣ is the radius of the O-ring seal 716A, 716B on an inner diameter of the inner body 704.

In some embodiments, a control system of the robot 1A-C may be configured to monitor the operational state of one or more actuators 100 that include the clutch 700 and generate notifications to a user when maintenance adjustments to the fluid 712 pressure are recommended. The control system may track various metrics indicative of prolonged fatigue and/or strain on the gearbox 108, including but not limited to: (i) total operational time of the actuator 100, (ii) cumulative rotations of the gearbox 108 as measured by encoders coupled to the motor 106 or the output adaptor 400, (iii) cumulative torque cycles experienced by the clutch 700, (iv) the number of slip events in which the clutch friction plates 706A, 706B slide against the output ring 108.2, and/or (v) temperature data from sensors positioned proximate to the gearbox 108 or the clutch 700, among other possibilities. Said metrics may be stored in a memory associated with the control system and compared against predetermined thresholds corresponding to expected fatigue or wear characteristics of the gearbox 108 and related components.

When one or more of the predetermined thresholds are met or exceeded, the control system may generate a notification to the user indicating that it is time to decrease the pressure of the fluid 712 in the fluid chamber 710 of the corresponding actuator 100. Said notification may be communicated via a display on the robot 1A-C, a remote computing device (e.g., a smartphone, tablet, or workstation), an audible alert, or any combination thereof. By decreasing the fluid 712 pressure, the clamping force applied by the clutch friction plates 706A, 706B against the output ring 108.2 is reduced, which in turn reduces the clutch breakaway torque value. This adjustment allows the clutch 700 to slip at lower torque levels, thereby reducing the peak stresses transmitted to the gearbox 108 and other downstream components. While this may result in slightly reduced torque transmission capacity for the actuator 100, it can help extend the operational lifespan of actuators that have accumulated significant wear, without risking catastrophic failure of the gearbox 108 or attached components.

In some embodiments, the control system may provide tiered notifications based on the severity or extent of accumulated wear. For example, an initial notification may recommend a first reduction in fluid 712 pressure after a first threshold of operational time or rotations has been met, and subsequent notifications may recommend additional pressure reductions as further thresholds are exceeded. The control system may also be configured to automatically adjust the pressure of the fluid 712 via the adjustment mechanism 720 in embodiments where a pressure adjustment motor is coupled to the hydraulic adjustment piston of the adjustment mechanism 720. In such embodiments, the control system may decrease the fluid 712 pressure without requiring manual intervention by the user, while still providing a notification that such an adjustment has been made. While this proactive maintenance approach may reduce the torque transmission capacity of the actuator 100, it extends the operational lifespan of actuators that have accumulated significant wear without risking catastrophic failure of the gearbox 108 or attached components, which may in turn reduce downtime of the robot 1A-C during extended operational deployments.

### Second Embodiment

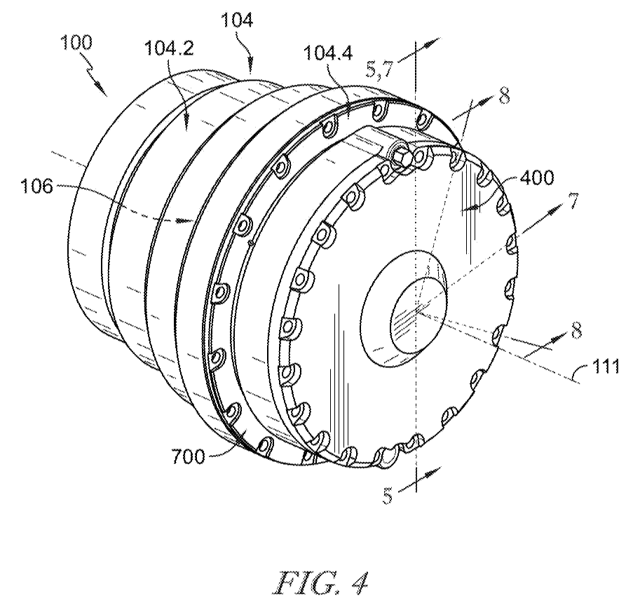

FIGS. 10A and 10B illustrate another actuator 1100 that uses a different clutch assembly 1700. Similar to the first embodiment, the illustrated clutch 1700 includes: (i) an outer body 1702, (ii) an inner body 1704, (iii) clutch friction plates 1706A, 1706B, (iv) a fluid chamber 1710, (v) fluid 1712 in the fluid chamber 1710, (vi) a seal 1716, and (vii) an adjustment mechanism. Most of the components of the clutch 1700 are substantially similar to the clutch 700 of FIGS. 4-9. However, instead of employing interlocking projections, a portion of the inner body 1704, such as the inner ring 1704.2, may be bonded to the outer ring 1702 at one end to transmit energy or torque between the inner body 1704 and the outer body 1702. At the opposite end of the inner body 1704, the seal 1716 is positioned between the inner body 1704 and the outer ring 1702 to form a fluid-tight seal for the fluid chamber 1710. The inner portion 1704, also referred to as the flexible coupling 1704, may include a flexible coupling portion 1704.6 configured to deflect when the fluid 1712 in the fluid chamber 1710 is pressurized. Accordingly, when the adjustment mechanism pressurizes the fluid 1712, the inner body 1704 is urged toward the output ring 1108.2. This movement urges the second clutch plate 1706B against the output ring 1108.2 and urges the output ring 1108.2 against the first clutch plate 1706A. The hydraulic pressure is configured not to cause the inner body 1704 to expand radially inward into contact with the gearbox 1108.

The outer body 1702 surrounds the gearbox 1108 (e.g., the circular spline 1108.2, the wave generator 1108.4, and the flexspline 1108.6). The outer body 1702 has a complex geometry that is configured to abut: (i) the bearing 1200, (ii) the inner body 1704, and (iii) the output ring 1108.2 of the gearbox 1108 as shown in FIGS. 10A and 10B. Said outer body 1702 extends between a first end of the outer body 1702 coupled to the actuator bearing 1200 and a second end coupled to the output adaptor 1400 so that the output adaptor 1400 rotates therewith.

As shown in FIGS. 10A and 10B, the outer body 1702 is also shaped to include a inner-body receiving space 1703A that is designed to receive the inner body 1704 of the clutch 1700. When the inner body 704 is arranged or received in the inner-body receiving space 703A of the outer body 702, the fluid chamber 710 is formed therebetween. The inner-body receiving space 1703A has (i) an annular inner groove 1703.2, (ii) an annular connecting section 1703.4, and (iii) an annular outer groove 1703.8 that each extend circumferentially about the axis 111. The inner body 1704 is bonded or coupled to the outer body 1702 at the annular inner groove 1703.2. The annular connecting section 1703.4 is sized to receive the flexible coupling portion 1704.6 of the inner body 1704 as it deflects (i.e., expands/contracts) based on the pressurization of the fluid 1712 in the fluid chamber 1710. The seal 1716 engages the outer body 1702 at the outer groove 1703.8.

### Inner Body

The inner body 1704 is positioned within the outer body 1702 to define the fluid chamber 1710 therebetween. Said inner body 1704 extends between a first end engaged with the annular inner groove 1703.2 of the outer body 1702 and second end engaged with the seal 1716 that seals against the annular outer groove 1703.8 as shown in FIGS. 10A and 10B. The first end of the inner body 1704 is bonded to the outer body 1702 to transfer energy or torque therebetween, while the second end of the inner body 1704 is not fixed relative to the outer body 1702.

As shown in FIGS. 10A and 10B, the inner body 1704 includes: (i) an inner ring section 1704.2 defining a first end; (ii) an outer ring section 1704.4 defining a second end; and (iii) a flexible coupling section 1704.6 extending between and interconnecting the inner ring section 1704.2 and the outer ring section 1704.4. The inner ring section 1704.2 extends circumferentially about the axis 111 and is received within the annular inner groove 1703.2 of the inner-body receiving space 1703A. The outer ring section 1704.4 also extends circumferentially about the axis 111 and is received within the annular outer groove 1703.4 of the inner-body receiving space 1703A, radially outward of the inner ring section 1704.2. The flexible coupling section 1704.6 extends circumferentially about the axis 111 and extends both axially and radially between the inner ring section 1704.2 and the outer ring section 1704.4. The flexible coupling section 1704.6 is configured to deflect axially relative to the outer body 1702, thereby permitting the outer ring section 1704.4 to move or translate relative to the outer body 1702.

As shown in FIGS. 10A and 10B, the inner body 1704 is also formed to include a seal receiver or grooves 1705.8. In the illustrative embodiment, the outer ring section 1704.4 is formed to include a seal receiver or groove 1705.8 that is designed to receive an extent of the seal 1716. The seal receiver or groove 1705.8 helps maintain engagement of the seal 1716 with the outer and inner bodies 1702, 1704 when the outer ring section 1704.4 moves or translates relative to the outer body 1702.

As shown in FIGS. 10A and 10B, the fluid chamber 1710 is formed between the outer body 1702 and the inner body 1704 when the inner body 1702 is arranged or received in the inner-body receiving space 1703A of the outer body 1702. The fluid chamber 1710 can be formed between: (i) the rear wall of the outer body 1702 (e.g., the annular connecting section 1703.4), (ii) the forward wall of the inner body 704 (e.g., the flexible coupling section 1704.6), (iii) the seal 716, (iv) a rear extent of the adjustment mechanism, etc. In the illustrative embodiment, the fluid chamber 710 extends circumferentially about the axis 111. Said fluid chamber 710 is designed to be filed with the fluid 712. The fluid may be any known fluid.

The at least one clutch friction plate 1706A, 1706B, illustratively two clutch plates 1706A, 1706B as shown in FIGS. 10A and 10B, is configured to transfer the torque to the outer body 1702 so that the outer body 1702 rotates with the gearbox 1108 and the motor 1106. The output ring 108.2 can have a disc configuration with planar surfaces 108.2.8.2, 108.2.8.4 that are positioned between at least one clutch plate 1706A, 1706B. The output ring 1108.2 can normally be compressed between clutch plates 1706A, 1706B so that there is normally no relative movement between the output ring 1108.2 and the clutch friction plates 1706A, 1706B and the outer body 1702 of the clutch 1700 will rotate at the same rotational velocity as the output ring 1108.2 of the gearbox 1108 coupled to the motor 1106.

As shown in FIGS. 10A and 10B, the clutch 700 of the illustrated embodiment includes: (i) a first clutch friction plate 1706A; and (ii) a second clutch friction plate 1706B. The first clutch friction plate 1706A is positioned on a first planar disc surface 1108.2.8.2 of the output ring 1108.2, axially between the output adaptor 1400 and the output ring 1108.2. The second clutch friction plate 1706B is positioned on a second planar disc surface 1108.2.8.4 of the output ring 1108.2, opposite the first planar disc surface 1108.2.8.2 and axially between the inner body 1704 and the output ring 1108.2. The second clutch friction plate 1706B is coupled to the inner body 1704 such that the second clutch friction plate 1706B can slide axially within the outer body 1702. For example, when the fluid 1712 in the fluid chamber 1710 urges the inner body 1704 outward, away from the motor 1106 and toward the output adaptor 1400, the inner body 1704 correspondingly moves the second clutch friction plate 1706B in the same direction.

The adjustment mechanism is configured to pressurize the fluid 1712 in the fluid chamber 1710 to (i) move or press the inner body 1704 towards the output ring 1108.2, (ii) press the second clutch friction plate 1706B against the second planar disc surface 1108.2.8.4 of the output ring 1108.2, and (iii) press the first planar disc surface 1108.2.8.2 of the output ring 1108.2 against the first clutch friction plate 1706A. The friction between the first clutch friction plate 1706A and the first planar disc surface 1108.2.8.2 of the output ring 1108.2 and friction between the second clutch friction plate 1706B and the second planar disc surface 1108.2.8.4 of the output ring 1108.2 causes the outer body 1702, and thus the output adaptor 1400, to rotate at the same rotational velocity as the gearbox 1108, and thus the motor 1106, when the fluid 1712 in the fluid chamber 1710 is pressurized. The outer body 1702 rotates with the gearbox 1108 until a rotational torque applied from the axle of the motor 1106 to the gearbox 1108 exceeds a predetermined torque.

In this embodiment, when the break-away slip torque is exceeded, both the output adaptor 1400 and the inner body 1704 can be fixed to, and rotate with, the outer body 1702. This causes (i) the first clutch friction plate 1706A to slide against the first planar disc surface 1108.2.8.2 and (ii) the second clutch friction plate 1706B to slide against the second planar disc surface 1108.2.8.4. Because both clutch friction plates 1706A, 1706B will slide against the output ring 1108.2 when the break-away slip torque is exceeded, the slip torque equation for the first embodiment of FIGS. 1-9 will be different than the slip torque equation for the second embodiment illustrated in FIGS. 10A and 10B.

The clutch or torque protection device 1700 is configured to protect the gearbox 1108 and devices coupled to the output adapter 1400 from being exposed to forces that can break or damage the coupled devices. The clutch 1700 can normally transmit the full torque power that the motor 1106 applies to the axle through the gearbox 1108 to the clutch 1700. In this normal state, the motor 1106 does not exceed a clutch breakaway torque value. In this state, the fluid 1712 pushes the inner body 1704 towards the output ring 1108.2. The outwardly directed force that is applied on the inner body 1704 causes a clamping force to be applied between the clutch friction plates 1706A, 1706B. Said clamping force applies pressure against the output ring 1108.2 to create enough friction to lock the output ring 1108.2 to the output adaptor 1400.

When the torque of the motor 1106 exceeds a clutch breakaway torque value, the friction associated with the clamping force via the clutch friction plates 1706A, 1706B is overcome. When said friction is overcome, the gearbox output ring 1108.2 can slide against both of the clutch friction plates 1706A, 1706B. If the torque applied to the clutch 1700 is reduced below the set breakaway torque value, then the gearbox output ring 1108.2 can stop sliding in relation to the clutch friction plates 1706A, 1706B. This enables the outer body 1702 and the output adaptor to rotate at the full rotational torque of the gearbox 1108.

The clutch breakaway torque value is adjustable and can be set to prevent the motor 1106 from transmitting torque above the design strength of the gearbox 1108 and components attached output adapter 1400. Thus, it can be important to know the design strengths of the gearbox 1108 and the components attached to the outer body 1702 and set the clutch breakaway torque to a value that is below all of these component design strengths. The clutch breakaway torque is proportional to the pressure against the inner body 1704 that controls the pressure of the clutch plates 1706A, 1706B against the output ring 1108.2. A higher pressure will result in a higher breakaway torque and a lower pressure will result in a lower breakaway torque. In different embodiments, various adjustment mechanisms can be used to control the pressure of the clutch plates 1706A, 1706B against the output ring 1108.2.

As discussed above, the slip torque equation for this embodiment is different because both clutch friction plates will slide against the output ring 1108.2 when the break-away slip torque is exceeded. For the embodiment illustrated in FIGS. 10A-10B, the equation for the break-away slip torque is ST = μ*P*((R*A)friction plate 1 + (R*A)friction plate 2), where ST is the maximum torque that is transmitted through the clutch 1700, μ is the coefficient of friction between the clutch fiction plates 1706A, 1706B and the output ring 1108.2, P is the pressure of the fluid 712, R is the effective radius of the clutch fiction plate 1706A that rests against the output adaptor 1400 or the effective radius of the clutch fiction plate 1706B coupled to the inner body 1704, and A is the effective area of the inner body 1704. Note that there are different R and A values for each of the friction plates 1706A, 1706B. Because the break-away slip torque will be higher for this clutch configuration if both are set at the same hydraulic pressure, the pressure P of the fluid 1712 can be substantially lower for the same slip torque setting for the clutch embodiment of FIGS. 10A and 10B.

It can be important to set up the clutch 1700 to a break-away slip torque that is below the maximum torque rating of the connected system components. For example, if the gearbox 1108 has a maximum torque rating of 300 Nm (newton meters), the hydraulic pressure can be adjusted so that the break-away slip torque of the clutch 1700 can be set to a safe value below 300 Nm such as 250 - 280 Nm to ensure that the gearbox does not reach its maximum torque rating. In some embodiments, a pressure gauge can be coupled to the volume of the fluid 712 and the hydraulic pressure mechanism can be adjusted so that the hydraulic pressure desired break-away slip torque. If this gearbox torque exceeds the break-away slip torque the output ring 1108.2 can rotate between the clutch friction plates 1706A, 1706B within the outer body 1702 to prevent overload torque from being transmitted to the gearbox 1108.

### Further Embodiments

While the foregoing embodiments employ planar friction interfaces, alternative geometries are also contemplated. In one embodiment, the output ring 108.2, 1108.2 is configured to present at least one frustoconical friction face in lieu of the planar disc surfaces 108.2.8.2, 108.2.8.4, wherein the frustoconical friction face is defined by a half-angle measured relative to the axis 111, and the corresponding clutch plate 706A, 706B, 1706A, 1706B presents a mating frustoconical contact surface having a complementary half-angle. The same hydraulic pressure mechanism and fluid chamber 710, 1710 generates the axial clamping force that presses the inner body 704, 1704 toward the output ring 108.2, 1108.2; however, because the contact interface is frustoconical rather than planar, the normal the foregoing embodiments employ planar friction interfaces, alternative geometries are also contemplated. In one embodiment, the output ring 108.2, 1108.2 is configured to present at least one frustoconical friction face in lieu of the planar disc surfaces 108.2.8.2, 108.2.8.4, wherein the frustoconical friction face is defined by a half-angle measured relative to the axis 111, and the corresponding clutch plate 706A, 706B, 1706A, 1706B presents a mating frustoconical contact surface having a complementary half-angle. The same hydraulic pressure mechanism and fluid chamber 710, 1710 generates the axial clamping force that presses the inner body 704, 1704 toward the output ring 108.2, 1108.2; however, because the contact interface is frustoconical rather than planar, the normal force at the friction interface is amplified by a factor related to the sine of the half-angle relative to the axially applied hydraulic force. Accordingly, a given fluid pressure P in the fluid chamber 710, 1710 produces a higher normal force at the friction interface of a frustoconical clutch than at the planar interface of the base embodiment, which in turn increases the break-away slip torque achievable at a given fluid pressure. This allows the clutch 700, 1700 to achieve a target break-away slip torque at a reduced operating fluid pressure relative to the planar-face embodiment, reducing stress on the seals 716A, 716B and extending seal service life. Furthermore, the frustoconical geometry provides self-centering of the output ring 108.2, 1108.2 relative to the clutch plate 706A, 706B, 1706A, 1706B during re-engagement following a slip event, reducing the likelihood of eccentric loading of the gearbox 108, 1108 output after torque restoration.

In another alternative embodiment, the circular spline or output ring 108.2, 1108.2 and the outer body 702, 1702 may be integrally formed with each other as a single, unitary component. This integral formation may be achieved through any suitable manufacturing method, including but not limited to casting, forging, machining from a single billet, or additive manufacturing. By integrally forming the output ring 108.2, 1108.2 and the outer body 702, 1702, the resulting structure may exhibit increased rigidity compared to embodiments in which the output ring 108.2, 1108.2 and the outer body 702, 1702 are separate components that are coupled together. This increased rigidity may provide more consistent loading on the clutch friction plates 706A, 706B, 1706A, 1706B, particularly in situations where eccentric axial loads are applied to the output adapter 400, 1400. In some aspects, when eccentric axial loads are applied to the output adapter 400, 1400, separate components may experience slight relative movement or deflection that could result in uneven pressure distribution across the clutch friction plates 706A, 706B, 1706A, 1706B. The integrally formed configuration may reduce or eliminate such relative movement, thereby maintaining a more uniform clamping force across the clutch friction plates 706A, 706B, 1706A, 1706B and improving the consistency of torque transmission through the clutch 700, 1700. Additionally, the integral formation may reduce the overall part count of the actuator assembly 100, 1100, potentially simplifying assembly and reducing manufacturing costs.

In another alternative embodiment, a closed-loop control scheme can detect and manage such slip events in real time. As one possibility, the control system of the humanoid robot 1A-C is configured to compute, in real time, a rotational velocity differential between the motor 106, 1106 and the output adaptor 400, 1400 of the actuator 100, 1100, wherein the rotational velocity of the motor 106, 1106 is measured by a first encoder coupled to the motor 106, 1106 and the rotational velocity of the output adaptor 400, 1400 is measured by a second encoder coupled to the output adaptor 400, 1400, both encoders being of the type disclosed herein including optical, magnetic, or capacitive encoders. The control system implements a finite-state machine comprising at least a first state in which the rotational velocity differential is within a tolerance band consistent with the gear ratio of the gearbox 108, 1108 and no slip is occurring between the clutch plate 706A, 706B, 1706A, 1706B and the output ring 108.2, 1108.2, and a second state in which the rotational velocity differential exceeds a slip threshold inconsistent with the gear ratio of the gearbox 108, 1108, indicating that relative sliding is occurring between the clutch plate 706A, 706B, 1706A, 1706B and the output ring 108.2, 1108.2. Upon transition to the second state, the control system commands the pressure adjustment motor coupled to the hydraulic adjustment piston of the adjustment mechanism 720 to produce a controlled reduction in fluid pressure in the fluid chamber 710, 1710, thereby intentionally reducing the break-away slip torque to permit the clutch 700, 1700 to complete the slip event under controlled conditions at a reduced interface contact pressure, which in turn reduces frictional heat generation and clutch plate 706A, 706B wear during the slip event relative to operation in which fluid pressure is maintained at maximum during slip.

The finite-state machine may further include a third state corresponding to re-engagement, entered when the rotational velocity differential returns to within the tolerance band of the gear ratio for a continuous duration sufficient to confirm that relative sliding between the friction plates 706A, 706B, 1706A, 1706B and the output ring 108.2, 1108.2 has ceased, whereupon the control system commands the pressure adjustment motor to restore the fluid pressure in the fluid chamber 710, 1710 to its pre-slip setpoint to re-establish the target break-away slip torque. Alternatively, the control system may apply a graduated pressure reduction protocol upon entering the second state, wherein the fluid pressure is reduced in a stepwise manner at a rate determined by the rate of change of the rotational velocity differential, such that rapidly developing slip events indicative of high-energy impacts such as a fall of the robot 1A-C trigger a faster pressure reduction than slowly developing slip events indicative of quasi-static overloads such as sustained load-bearing against a stiff environment. The measurable technical benefit of this closed-loop slip detection and pressure feedback architecture is a reduction in clutch plate 706A, 706B and output ring 108.2, 1108.2 wear per slip event, achieved by dynamically reducing interface contact pressure during slip rather than maintaining maximum clamping force throughout the slip event.

In yet another alternatively embodiment, wear at the sliding friction interfaces is directly monitored via a sensor embedded in the friction plates themselves. In one such example, at least one of the clutch plate 706A, 706B, 1706A, 1706B comprises a friction material body formed by an insert-molding process consistent with the housing manufacturing method disclosed herein, wherein a wear sensor element is encapsulated within the friction material body during the molding process such that the wear sensor element is positioned at a predetermined depth below the friction interface surface that contacts the planar disc surface 108.2.8.2, 108.2.8.4 of the output ring 108.2, 1108.2. The wear sensor element comprises a conductive track formed from a suitable resistive or capacitive material whose electrical property resistance or capacitance respectively changes as the friction material surrounding the track is consumed by frictional wear against the output ring 108.2, 1108.2 during slip events. As the friction material at the contact surface wears toward the wear sensor element, the effective cross-sectional area of the conductive track is progressively reduced, producing a monotonic change in the measured electrical property that the control system of the robot 1A-C correlates to remaining friction material thickness. The control system thereby obtains a direct measurement of friction plate wear rather than an inference derived from slip event counting or operational time metrics, enabling more accurate determination of the remaining service life of the clutch plate 706A, 706B, 1706A, 1706B and more precise timing of the pressure reduction notifications and automated pressure adjustments disclosed herein.

According to an aspect of the present disclosure, the wear sensor element is electrically connected to the control system via conductive paths routed through the outer body 702, 1702 of the clutch 700, 1700, wherein the conductive paths pass through sealed feedthroughs formed in the outer body 702, 1702 that maintain the fluid-tight integrity of the fluid chamber 710, 1710. In an alternative embodiment, the wear sensor element is a passive resonant circuit whose resonant frequency shifts as the friction material is consumed, and the control system interrogates the sensor wirelessly via an inductive coupling antenna positioned proximate to the outer body 702, 1702, eliminating the need for conductive feedthroughs through the outer body 702, 1702. In a further alternative embodiment, a wear sensor element is embedded in each of the first and second clutch plate 706A, 706B, 1706A, 1706B at different depths below their respective friction interface surfaces, such that the control system receives independent wear measurements from both friction plate interfaces and can detect asymmetric wear for example, caused by misalignment of the output ring 108.2, 1108.2 that would not be detectable from a single sensor. The measurable technical benefit of this embedded sensor architecture is a reduction in unplanned actuator 100, 1100 downtime attributable to unexpected friction plate failure, achieved by providing the control system with directly measured plate thickness data that enables planned maintenance scheduling before the friction material is consumed to a thickness insufficient to maintain the required break-away slip torque.

In yet another alternative embodiment, an over-pressure protection feature may be provided as part of the clutch 700, 1700. For example, the clutch 700, 1700 may include a burst disk element integrated into a wall surface of the fluid chamber 710, 1710—such as the rear groove surface 703.2.4 or the forward inner-ring surface 704.2.4 of the first embodiment, or the annular connecting section 1703.4 of the second embodiment wherein the burst disk element is formed from a suitable metal selected for a predetermined burst pressure that exceeds the maximum intended operating fluid pressure in the fluid chamber 710, 1710. When the fluid pressure in the fluid chamber 710, 1710 exceeds the burst disk's predetermined burst pressure due to an anomalous condition (e.g., thermal expansion of the fluid 712, 1712 caused by exposure of the robot 1A-C to elevated ambient temperatures, runaway operation of the pressure adjustment motor driving the hydraulic adjustment piston beyond its intended travel, hydraulic lock caused by entrapment of gas that was not removed by the gas bleed piston during assembly, etc.) the burst disk ruptures in a controlled manner, venting the fluid 712, 1712 from the fluid chamber 710, 1710 into a containment reservoir formed within the outer body 702, 1702. The venting of fluid 712, 1712 eliminates the pressurized clamping force on the inner body 704, 1704, causing the clutch 700, 1700 to transition to a near-zero break-away slip torque condition in which the output ring 108.2, 1108.2 can rotate freely relative to the clutch plate 706A, 706B, 1706A, 1706B. This, in turn, may protect the seals 716A, 716B, the outer body 702, 1702, and the gearbox 108, 1108 from pressure-induced structural failure that could result from catastrophic seal blowout.

Extending this break-away slip torque configuration, a fail-safe hybrid arrangement may be employed as follows. In one embodiment, the torque protection apparatus 700, 1700 further comprises a resilient biasing member arranged in parallel with the fluid chamber 710, 1710, such that the resilient biasing member applies a baseline axial clamping force against the inner body 704, 1704 independently of the hydraulic pressure state of the fluid 712, 1712. The resilient biasing member is selected to deflect before the yield strength of any downstream component is exceeded, thereby establishing a minimum break-away slip torque that is maintained even upon complete loss of fluid pressure caused by, for example, seal degradation of seals 716A, 716B, fluid 712, 1712 leakage, or the over-press protection discussed above. The hydraulic pressure mechanism then adds a variable incremental clamping force atop this passive baseline, such that the total axial force pressing the inner body 704, 1704 toward the output ring 108.2, 1108.2 is the sum of the biasing-member preload and the fluid-pressure-derived force. This architecture ensures that the clutch 700, 1700 retains torque-transmission capability sufficient to prevent uncontrolled collapse of the humanoid robot 1A-C—for example at a knee actuator (J14) or hip flex actuator (J11)—even when the hydraulic subsystem is in a degraded state, thereby addressing a fail-safe requirement that some purely hydraulic clamping systems might not satisfy.

It should be understood that each of the alternative embodiments discussed above may be in combination any number of the other embodiments discussed herein.

### Industrial Application

While the present disclosure shows several illustrative embodiments of a robot (in particular, a humanoid robot), it should be understood that these embodiments are designed to be examples of the principles of the disclosed assemblies, methods, and systems. They are not intended to limit the broad aspects of the disclosed concepts solely to the specific embodiments that have been illustrated. As will be realized by one skilled in the art, the disclosed robot, and its associated functionality and methods of operation, are capable of other and different configurations. Furthermore, several of its details are capable of being modified in various respects, all without departing from the fundamental scope of the disclosed methods and systems. For example, one or more of the disclosed embodiments, either in part or in whole, may be combined with another disclosed assembly, method, and system to create hybrid implementations. As such, one or more steps from the diagrams or components in the Figures may be selectively omitted or combined in a manner that is consistent with the principles of the disclosed assemblies, methods, and systems. Additionally, the order of one or more steps from the arrangement of components may be omitted or performed in a different order than what is explicitly described. Accordingly, the drawings, diagrams, and the detailed description provided herein are to be regarded as illustrative in nature, and not as restrictive or limiting, of the said humanoid robot. It should be understood that the use of the word “or” when separating element names in connection with a single reference number indicates that the same structure can have two or more different names. For example, the phrase “end effector or hand assembly 56” indicates that the structure that is referenced by the number 56 can be referred to or claimed as either an “end effector” or a “hand assembly.”

While the above-described methods and systems are primarily designed for use with a general-purpose humanoid robot, it should be understood that the disclosed assemblies, components, learning capabilities, or kinematic capabilities may be adapted for use with other types of robots. Examples of other such robots include, but are not limited to: an articulated robot (e.g., an arm having two, six, or ten degrees of freedom, etc.), a cartesian robot (e.g., rectilinear or gantry robots, robots having three prismatic joints, etc.), a Selective Compliance Assembly Robot Arm (SCARA) robot (e.g., a robot with a donut -shaped work envelope, with two parallel joints that provide compliance in one selected plane, with rotary shafts positioned vertically, with an end effector attached to an arm, etc.), a delta robot (e.g., a parallel link robot with parallel joint linkages connected with a common base, having direct control of each joint over the end effector, which may be used for pick-and-place or product transfer applications, etc.), a polar robot (e.g., a robot with a twisting joint connecting the arm with the base and a combination of two rotary joints and one linear joint connecting the links, having a centrally pivoting shaft and an extendable rotating arm, a spherical robot, etc.), a cylindrical robot (e.g., a robot with at least one rotary joint at the base and at least one prismatic joint connecting the links, with a pivoting shaft and an extendable arm that moves vertically and by sliding, with a cylindrical configuration that offers vertical and horizontal linear movement along with rotary movement about the vertical axis 111, etc.), a self-driving car, a kitchen appliance, construction equipment, or a variety of other types of robot systems. The robot system may include one or more sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art and is used in connection with robot systems. Likewise, the robot system may omit one or more of the aforementioned sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art to be used in connection with robot systems. In other embodiments, other configurations or components may be utilized.

As is well known in the data processing and communications arts, a general-purpose computer typically comprises a central processor or other processing device, an internal communication bus, various types of memory or storage media (e.g., RAM, ROM, EEPROM, cache memory, disk drives, etc.) for code and data storage, and one or more network interface cards or ports for communication purposes. The software functionalities that are described herein involve programming, which includes executable code as well as associated stored data. This software code is executable by the general-purpose computer. In operation, the code is stored within the memory of the general-purpose computer platform. At other times, however, the software may be stored at other locations or transported for loading into the appropriate general-purpose computer system.

A server, for example, typically includes a data communication interface for engaging in packet data communication over a network. The server also includes a central processing unit (CPU), which may be in the form of one or more processors, for executing the program instructions. The server platform typically includes an internal communication bus, program storage, and data storage for the various data files that are to be processed or communicated by the server, although the server often receives its programming and data via network communications. The hardware elements, operating systems, and programming languages of such servers are conventional in nature, and it is presumed that those who are skilled in the art are adequately familiar therewith. The server functions may be implemented in a distributed fashion on a number of similar platforms to distribute the processing load.

Hence, aspects of the disclosed methods and systems that are outlined above may be embodied in the form of computer programming. Program aspects of the technology may be thought of as “products” or “articles of manufacture,” which are typically in the form of executable code or associated data that is carried on or embodied in a type of machine-readable medium. “Storage” type media includes any or all of the tangible memory of the computers, processors, or the like, or any associated modules thereof. This may include various semiconductor memories, tape drives, disk drives, and the like, which may provide non-transitory storage at any time for the software programming. All or portions of the software may at times be communicated through the Internet or various other telecommunication networks. Thus, another type of media that may bear the software elements includes optical, electrical, and electromagnetic waves, such as those that are used across physical interfaces between local devices, through wired and optical landline networks, and over various air-links. The physical elements that carry such waves, such as wired or wireless links, optical links, or the like, also may be considered as media that bear the software. As used herein, unless specifically restricted to non-transitory, tangible “storage” media, terms such as computer or machine “readable medium” refer to any medium that participates in the process of providing instructions to a processor for execution.

A machine-readable medium may take many forms, including but not limited to, a tangible storage medium, a carrier wave medium, or a physical transmission medium. Non-volatile storage media include, for example, optical or magnetic disks, such as any of the storage devices in any computer or computers or the like, such as may be used to implement the disclosed methods and systems. Volatile storage media include dynamic memory, such as the main memory of such a computer platform. Tangible transmission media include components such as coaxial cables, copper wire, and fiber optics, including the wires that comprise a bus within a computer system. Carrier-wave transmission media can take the form of electric or electromagnetic signals, or acoustic or light waves, such as those that are generated during radio frequency (RF) and infrared (IR) data communications. Common forms of computer-readable media therefore include, for example: a floppy disk, a flexible disk, a hard disk, magnetic tape, any other magnetic medium, a CD-ROM, a DVD or DVD-ROM, any other optical medium, punch cards, paper tape, any other physical storage medium with patterns of holes, a RAM, a PROM and EPROM, a FLASH-EPROM, any other memory chip or cartridge, a carrier wave that is transporting data or instructions, cables or links that are transporting such a carrier wave, or any other medium from which a computer can read programming code or data. Many of these forms of computer-readable media may be involved in carrying one or more sequences of one or more instructions to a processor for execution.

It is to be understood that the invention is not limited to the exact details of construction, operation, exact materials, or specific embodiments shown and described herein, as obvious modifications and equivalents will be apparent to one who is skilled in the art. While the specific embodiments have been illustrated and described in detail, numerous modifications may come to mind without significantly departing from the spirit of the invention, and the scope of protection is only limited by the scope of the accompanying Claims. In the drawings, some structural or method features may be shown in specific arrangements or orderings. However, it should be appreciated that such specific arrangements or orderings may not be required. Rather, in some embodiments, such features may be arranged in a different manner or order than shown in the illustrative figures. Additionally, the inclusion of a structural or method feature in a particular figure is not meant to imply that such a feature is required in all embodiments and, in some embodiments, may not be included or may be combined with other features.

It should also be understood that the term “substantially” as utilized herein means a deviation of less than 15% and preferably less than 5%. It should also be understood that the term “near” means within 10 cm, the term “proximate” means within 5 cm, and the term “adjacent” means within 1 cm. It should also be understood that other configurations or arrangements of the above-described components are contemplated by this Application. Moreover, the description provided in the background section should not be assumed to be prior art merely because it is mentioned in or associated with the background section. The background section may include information that describes one or more aspects of the subject of the technology. Finally, the mere fact that something is described as conventional does not mean that the Applicant admits it is prior art.

The following applications are hereby incorporated by reference for any purpose: (i) PCT Application Nos. PCT/US25/10425, PCT/US25/11450, PCT/US25/12544, PCT/US25/16930, PCT/US25/19793, PCT/US25/23064, PCT/US25/23325, PCT/US25/24817, PCT/US25/25005, PCT/US26/13952, and PCT/US26/13976; (ii) U.S. Patent Application Nos. 18/919,263, 18/919,274, 19/033,973, 19/038,657, 19/064,596, 19/066,122, 19/180,106, 19/249,517, 19/286,240, 19/319,712, 19/323,751, 19/324,342, 19/325,415, 19/325,486, 19/329,008, 19/329,485, 19/337,845, 19/337,852, 19/337,899, 19/342,470, 19/342,474, 19/347,690, 19/347,994, 19/351,294, 19/352,959, 19/355,393, 19/355,531, 19/355,786, 19/357,879, 19/362,617, 19/362,708, 19/377,127, 19/378,092, 19/378,308, 19/384,836, 19/442,030, 19/443,231, 19/443,345, 19/452,151, 19/452,205, 19/530,199, 19/536,458, 19/538,967, 19/550,067, 19/552,233, 19/557,667, 19/557,966, 19/557,999, 19/558,158, 19/558,420, 19/565,007, 19/565,133, 19/565,304, 19/565,382, 19/568,750, 19/577,331, 19/642,595, 19/655,695, 19/656,881, 19/659,848, 19/661,670, 19/671,220, 19/683,700, 19/717,841, 19/733,685, 19/733,780, 19/733,769, 19/733,673, 19/733,654, 19/733,899; and (iii) U.S. Design Patent Application Nos. 29/889,764, 29/928,748, 29/935,680, 29/954,572, 29/967,462, 29/993,115, and 29/998,761; (iv) U.S. Provisional Patent Application Nos. 63/556,102, 63/557,874, 63/558,373, 63/561,307, 63/561,311, 63/561,313, 63/561,315, 63/561,317, 63/561,318, 63/564,741, 63/565,077, 63/573,226, 63/573,528, 63/573,543, 63/574,349, 63/614,499, 63/615,766, 63/617,762, 63/620,633, 63/625,362, 63/625,370, 63/625,381, 63/625,384, 63/625,389, 63/625,405, 63/625,423, 63/625,431, 63/626,028, 63/626,030, 63/626,032, 63/626,034, 63/626,035, 63/626,037, 63/626,039, 63/626,040, 63/626,105, 63/632,630, 63/632,683, 63/633,113, 63/633,405, 63/633,920, 63/633,931, 63/633,941, 63/634,042, 63/634,599, 63/634,697, 63/635,152, 63/677,087, 63/685,856, 63/690,334, 63/692,747, 63/692,765, 63/694,253, 63/694,304, 63/696,507, 63/696,533, 63/697,793, 63/697,816, 63/700,749, 63/702,185, 63/705,715, 63/706,768, 63/707,547, 63/707,897, 63/707,949, 63/708,003, 63/715,117, 63/715,270, 63/720,222, 63/722,057, 63/753,670, 63/757,440, 63/759,665, 63/760,617, 63/763,209, 63/766,911, 63/770,620, 63/770,654, 63/772,440, 63/773,078, 63/776,429, 63/792,520, 63/819,533, 63/837,511, 63/837,536, 63/839,386, 63/839,517, 63/839,612, 63/839,880, 63/839,918, 63/841,314, 63/852,423, 63/860,403, 63/870,426, 63/883,647, 63/895,312, 63/895,831, 63/895,874, 63/976,432, 63/976,455, 63/977,208, and 64/038,811, each of which is expressly incorporated by reference herein in its entirety.

In this Application, to the extent any U.S. patents, U.S. patent applications, or other materials (e.g., articles) have been incorporated by reference, the text of such materials is only incorporated by reference to the extent that it does not conflict with the materials, statements, and drawings set forth herein. In the event of such a conflict, the text of the present document controls, and terms in this document should not be given a narrower reading in virtue of the way in which

those terms are used in other materials incorporated by reference. It should also be understood that structures or features not directly associated with a robot cannot be adopted or implemented into the disclosed humanoid robot without careful analysis and verification of the complex realities of designing, testing, manufacturing, and certifying a robot for the completion of usable work nearby or around humans. Theoretical designs that attempt to implement such modifications from non-robotic structures or features are insufficient, and in some instances, woefully insufficient, because they amount to mere design exercises that are not tethered to the complex realities of successfully designing, manufacturing, and testing a robot.

1. A humanoid robot comprising:
a torque protection apparatus for an actuator of the humanoid robot, the torque protection apparatus comprising:
a gearbox having (i) an input coupled to a motor and (ii) an output ring having a first planar surface and a second planar surface;
an outer body surrounding the gearbox and coupled to an output adaptor;
an inner body positioned within the outer body;
a first clutch friction plate positioned between the first planar surface of the output ring and the output adaptor;
a second clutch friction plate positioned between the second planar surface of the output ring and the inner body;
a fluid chamber defined between the inner body and the outer body;
fluid contained within the fluid chamber; and
a hydraulic adjustment piston configured to pressurize the fluid within the fluid chamber to bias the inner body toward the output ring, wherein:
the torque protection apparatus is configured to operate in a first state when a rotational torque transmitted through the gearbox is below a threshold torque value, wherein the pressurized fluid causes the inner body to press the first and second clutch friction plates against the first and second planar surfaces of the output ring with sufficient force such that the first and second clutch friction plates do not slip relative to the output ring, thereby causing the output adaptor to rotate at a same rotational velocity as the output ring; and
the torque protection apparatus is configured to operate in a second state when the rotational torque transmitted through the gearbox exceeds the threshold torque value, wherein the first and second clutch friction plates slip relative to the first and second planar surfaces of the output ring, thereby preventing transmission of torque exceeding the threshold torque value to the output adaptor.

2. The humanoid robot of claim 1, wherein the inner body includes an inner ring section, an outer ring section, and a plurality of circumferentially spaced projections defining receivers therebetween, the receivers receiving projections of the outer body to transmit torque while permitting axial translation of the inner body.

3. The humanoid robot of claim 1, wherein the hydraulic adjustment piston has external threads engaged with internal threads of a pressure bore in the outer body and carries one or more O-ring seals that slide against a smooth inner diameter of the pressure bore.

4. The humanoid robot of claim 1, further comprising a gas bleed piston mounted in a bleed bore separate from a pressure bore of the hydraulic adjustment piston and a second passageway from the bleed bore to the fluid chamber, the gas bleed piston being sealed when gas has been removed from the fluid chamber.

5. The humanoid robot of claim 1, further comprising a pressure adjustment motor coupled to the hydraulic adjustment piston and configured to adjust a position of the hydraulic adjustment piston within a pressure bore to change pressure of the fluid and thereby change the threshold torque value.

6. The humanoid robot of claim 1, further comprising a control system configured to (i) track at least one wear metric selected from total operational time, cumulative gearbox rotations, cumulative torque cycles, slip-event count, and temperature proximate the gearbox or the torque protection apparatus, and (ii) generate a notification recommending reduction of fluid pressure when a predetermined threshold value for a tracked wear metric is met.

7. The humanoid robot of claim 1, wherein the gearbox is a hollow-type strain wave gearbox comprising a wave generator coupled to the motor, a flexspline, and a circular spline forming the output ring, and wherein the first and second planar surfaces are defined on a mounting projection that radially extends from a cylindrical member of the circular spline.

8. A humanoid robot comprising: an actuator comprising:
an electric motor;
a strain wave gearbox drivable by the motor and having a circular spline that forms an output ring with first and second opposed planar disc surfaces;
an output adaptor coupled to a joint of a humanoid robot;
a first friction plate clamped between the first planar disc surface and the output adaptor;
a second friction plate clamped against the second planar disc surface; and
a sealed annular hydraulic chamber holding a captive incompressible liquid whose pressure axially clamps the friction plates against the output ring such that:
the actuator transmits full motor torque to the output adaptor via the friction plates when applied torque is below a threshold torque set by the liquid pressure; and
the output ring slides against the friction plates when applied torque exceeds the threshold torque.

9. The humanoid robot of claim 8, wherein the sealed annular hydraulic chamber is bounded between an outer body and an inner body that are mutually interlocked by circumferentially spaced projections and complementary receivers configured to transfer torque while permitting axial translation of the inner body toward the output ring.

10. The humanoid robot of claim 8, further comprising a hydraulic adjustment piston mounted within a threaded pressure bore of an outer body and in fluid communication with the sealed annular hydraulic chamber through a channel, wherein advancing the hydraulic adjustment piston into the pressure bore increases the liquid pressure.

11. The humanoid robot of claim 8, wherein the hydraulic chamber further communicates with a separate bleed bore containing a gas bleed piston configured to be sealed against the bleed bore after gas removal from the captive incompressible liquid.

12. The humanoid robot of claim 8, further comprising a pressure adjustment motor coupled to a hydraulic adjustment piston that varies the liquid pressure within the sealed annular hydraulic chamber to change the threshold torque.

13. The humanoid robot of claim 8, further comprising a threaded hydraulic adjustment piston mounted within a pressure bore in an outer body surrounding the gearbox, and a channel extending from the annular hydraulic chamber to the pressure bore, wherein inward advancement of the piston reduces total fluid volume and increases the liquid pressure.

14. The humanoid robot of claim 8, further comprising an outer body coupled to the output adaptor and an inner body received within the outer body, the inner body having circumferentially spaced projections received in mating receivers of the outer body to transfer torque while permitting axial translation of the inner body under liquid pressure.

15. The humanoid robot of claim 8, further comprising an outer body coupled to the output adaptor and an inner body bounding the sealed annular hydraulic chamber, wherein the inner body comprises a plurality of projections spaced apart circumferentially about a rotational axis that interlock with a plurality of receivers on the outer body to transfer torque while permitting axial translation of the inner body.

16. The humanoid robot of claim 8, further comprising a control system and a pressure adjustment motor, wherein the control system is configured to track a number of slip events of the output ring and command the pressure adjustment motor to decrease the liquid pressure when the number of slip events exceeds a predetermined threshold, thereby reducing the threshold torque as wear accumulates.

17. A humanoid robot comprising: a plurality of rotary actuators positioned at respective joints of the humanoid robot, each rotary actuator comprising:
a strain wave gearbox comprising an output ring with opposed planar disc surfaces;
an outer body surrounding the gearbox and coupled to an output adaptor;
an inner body within the outer body;
at least one friction plate axially clamped between the output ring and the output adaptor;
a sealed annular chamber holding a captive incompressible liquid between the inner body and the outer body;
a pressure mechanism accessible through the outer body and configured to set a pressure of the captive liquid, whereby each rotary actuator is independently configured with a breakaway slip torque corresponding to the liquid pressure of that rotary actuator; and
a control system that monitors an operational metric for each said rotary actuator and generates a notification when the operational metric meets a predetermined threshold, the notification identifying a reduction in liquid pressure for the corresponding rotary actuator.

18. The humanoid robot of claim 17, wherein each said rotary actuator further comprises a gas bleed piston mounted in a bleed bore separate from a pressure bore of the pressure mechanism to remove trapped gas from the annular chamber independently of pressure setting.

19. The humanoid robot of claim 17, wherein at least one of the rotary actuators further comprises a pressure adjustment motor coupled to the pressure mechanism and operable to automatically change the liquid pressure of that rotary actuator.

20. The humanoid robot of claim 17, wherein the breakaway slip torque of at least one said rotary actuator is set below a maximum torque rating of 300 Nm and within a range of 250 Nm to 280 Nm.

21. The humanoid robot of claim 17, further comprising a pressure adjustment motor coupled to the pressure mechanism, wherein the control system automatically commands the pressure adjustment motor to decrease the pressure of the captive liquid without manual intervention when the operational metric meets the predetermined threshold.

22. The humanoid robot of claim 17, further comprising a gas bleed piston mounted in a bleed bore in the outer body separate from the pressure mechanism, wherein the gas bleed piston is configured to remove gas from the sealed annular chamber to maintain incompressibility of the captive liquid.

23. The humanoid robot of claim 17, wherein the breakaway slip torque is set to a value in a range of 250 Nm to 280 Nm to prevent overload torque from being transmitted through the strain wave gearbox having a maximum torque rating of 300 Nm.

24. The humanoid robot of claim 17, wherein the inner body comprises an inner ring section bonded to the outer body and a flexible coupling section configured to axially deflect relative to the outer body to press against the output ring when the captive liquid is pressurized.
